(19) United States
(12) Patent Application Publication
(10) Pub. No.: US 2026/0359858 A1
(43) Pub. Date: Nov. 12, 2026

(54) DATA PLATFORM FOR DETERMINING METRICS FOR SPONSORSHIP AUDIENCES

(71) Applicant: AIM Sport Development AG, Lucerne (CH)

(72) Inventors: Jeffrey Benjamin Katz, Rockville, MD (US); Vishva-Urmi Dushyant Banker, San Diego, CA (US); David Wayne Bachowski, Buffalo, NY (US); Adam John Holt, Kleinburg (CA)

(73) Assignee: AIM Sport Development AG, Lucerne (CH)

(21) Appl. No.: 19/669,024

(22) Filed: May 6, 2026

Related U.S. Application Data
(60) Provisional application No. 63/800,957, filed on May 6, 2025.

(51) Int. Cl. G06Q 30/0242

(52) U.S. Cl. CPC G06Q 30/0243; G06Q 30/0244

(57) ABSTRACT

The present disclosure relates generally to a framework for exchanging data over a network, which implements a data platform for determining sponsorship audience and tracking metrics related to lift in sales for advertisements, among other types of metrics.

### CROSS-REFERENCE TO RELATED APPLICATIONS

The present patent application claims the priority benefit of U.S. Provisional Patent Application No. 63/800,957 filed May 6, 2025, the disclosures of which are incorporated by reference herein.

### FIELD

The present disclosure relates generally to a framework through which a data platform for determining sponsorship metrics is implemented.

### BACKGROUND

In the advertisement and marketing space, tracking/isolating the lift in sales that can be attributed to specific advertisements is crucial in determining the true impact of expenditures from such advertisement and marketing. For sports & entertainment sponsorships or sports marketing and the broader advertising sector, there are unique challenges and deficiencies in existing approaches which can inhibit an accurate determination of metrics that pinpoint the exact lift in sales from advertisement expenditures for particular audience segments.

### SUMMARY

Disclosed embodiments provide a framework for exchanging data over a network, which implements a data platform for determining sponsorship audience and tracking metrics related to lift in sales for advertisements, among other types of metrics. According to some embodiments, a computer-implemented method is provided. The computer-implemented method comprises obtaining data corresponding to different audiences and transactions. The data is associated with a set of common keys that uniquely identify different households. The computer-implemented method further comprises generating a set of data segments from the data. The set of data segments corresponds to different customer types and the set of common keys. The computer-implemented method further comprises transforming the set of data segments using a data transformation function. The data transformation function is selected based on a probability threshold. Further, the probability threshold corresponds to a probability of statistical means between exposed and unexposed groups being identical. The computer-implemented method further comprises performing a back transformation of the set of data segments according to an inverse of the data transformation function to obtain a set of values corresponding to the set of data segments. The computer-implemented method further comprises processing the set of values corresponding to the set of data segments to generate a set of metrics for sponsorships associated with the different audiences and the different households.

In some embodiments, the computer-implemented method further comprises processing the data through one or more machine learning customer segmentation models to generate the set of data segments from the data.

In some embodiments, the computer-implemented method further comprises generating a set of trend insights and a set of actionable insights based on the set of metrics. The set of trend insights and the set of actionable insights include recommendations for new sponsorship investments.

In some embodiments, the computer-implemented method further comprises providing benchmarking data for existing properties compared to other properties. The benchmarking data is generated using the metrics.

In some embodiments, the computer-implemented method further comprises generating a set of alerts corresponding to the sponsorships. The set of alerts is triggered according to detected changes to the set of metrics over time. The computer-implemented method further comprises transmitting one or more alerts from the set of alerts in response to a change to the set of metrics.

In some embodiments, the set of metrics includes at least a sales lift value of the sponsorships and a sales lift percentage of the sponsorships.

In some embodiments the data transformation function is selected from a set of data transformation functions including a square root function, a cubic root function, and a natural logarithm function.

In an example, a system comprises one or more processors and memory including instructions that, as a result of being executed by the one or more processors, cause the system to perform the processes described herein. In another example, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 shows an illustrative example of a system for exchanging data over a network, which implements a data platform for determining sponsorship audience and tracking metrics related to lift in sales for advertisements, among other types of metrics in accordance with at least one embodiment;

FIG. 2 shows an illustrative example of a chart illustrating an example of return on advertising (“ad”) spending (“ROAS”) from a sponsorship or group of sponsorships of sports properties in accordance with at least one embodiment;

FIG. 3 shows an illustrative example of a chart illustrating an existing example of determining lift calculations in accordance with at least one embodiment;

FIG. 4 shows an illustrative example of a chart illustrating an existing example of hypothesis testing based on a t-test in accordance with at least one embodiment;

FIG. 5 shows illustrative examples of charts illustrating various data transformations corresponding to data (e.g., spending data) that does not follow a normal distribution in accordance with at least one embodiment;

FIG. 6 shows an illustrative example of a chart illustrating a box plot of data in accordance with at least one embodiment;

FIG. 7 shows an illustrative example of a data flow for audience targeting and attribution in accordance with at least one embodiment;

FIG. 8 shows an illustrative example of a user interface in accordance with at least one embodiment;

FIG. 9 shows an illustrative example of a user interface in accordance with at least one embodiment;

FIG. 10 shows an illustrative example of a user interface in accordance with at least one embodiment;

FIG. 11 shows an illustrative example of insights engine data in accordance with at least one embodiment;

FIGS. 12-15 show illustrative examples of interfaces for various insights engine data in accordance with at least one embodiment;

FIGS. 16-17 show illustrative examples of data in accordance with at least one embodiment;

FIG. 18 shows an illustrative example of a chart and of a formula for fan avidity in accordance with at least one embodiment;

FIG. 19 shows an illustrative example of results for fan avidity in accordance with at least one embodiment;

FIGS. 20-23 shows illustrative examples of portions of an example data flow for a process for attribution, including handling different customer types in calculating ROAS in accordance with at least one embodiment;

FIG. 24 shows an illustrative example of a diagram illustrating an unexposed group creation that enables finding sports audiences that are similar yet not exposed to any sponsorship by the brand in accordance with at least one embodiment;

FIG. 25 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

As mentioned herein, the term “advertisements” or “ads” in sports sponsorships often refer to TV visible signage/branding on the side of a sports playing field (e.g., basketball court, baseball park, football field, etc.), an in-game promotion, a radio spot, a television commercial, a billboard, or any organic re-posting of sports content that contains a sponsors branding, and the like.

As referred to herein, “exposed audience” refers to an audience related to purchasers of designated team merchandise from an origin date to a particular season date, a second audience related to attendees of a designated team's home games, in the respective season, or a third audience related to viewers who consumed a pre-defined amount (e.g., 30 or more minutes, etc.) of designated team sponsored content over a pre-defined number of home games (e.g., 2 or more home games, etc.), in the respective season, a fourth audience related to people who exhibited online behaviors such as visiting a website page that displayed an article about a specific team, a fifth audience related to people who browsed social media content related to a particular team, or any combination of the aforementioned audiences. Furthermore “exposed audience” may also refer to all audiences above and can also refer to audiences that were exposed to a specific sponsors' branding.

As referred to herein, “unexposed audience” refers to households identified as sports fans, that were not exposed to home games of sponsored teams in the pre-period and/or did not purchase designated team merchandise from an origin data to a particular season date. In some embodiments, a given unexposed audience can generally refer to households that were not exposed to a particular branding (e.g., sports team, product, etc.).

As referred to herein, “net new customers” refers to households that purchased a product in the post-period, but did not purchase a product in the pre-period or treatment period.

As referred to herein, “non-returning customers” refers to households that purchased a product in the pre-period, but did not purchase in the treatment or post-period.

The following describes various definitions that are mentioned herein:

Assisted Profit: Total retail profit by customers exposed to a property during the defined sponsorship period.

Profit Lift or Incremental Profit: Calculated as ‘Retail Profit Lift’+‘Concessions Profit’. The profit lift or incremental profit is the difference in actual retail profit, during the defined sponsorship period, by customers exposed to a property compared to the estimated retail profit brand would have generated without these customers being exposed to said property.

Retail Profit Lift: ‘Recurring Customer Profit Lift’+‘New Customer Profit’−‘Customer Churn’. Recurring Customer Profit Lift is the difference in profit during the sponsorship period from recurring customers exposed to a property compared to recurring customers that were not exposed to the property. New Customer Profit is the profit from customers who bought after being exposed to the property but did not buy prior to the sponsorship. Customer Churn is the profit lost from customers who bought before the sponsorship but did not buy after being exposed to the property.

Concessions Profit: In-stadium concessions profit during the exposure period.

Profit Lift/Incremental Profit (%): The above but expressed as a %.

Profit on Ad Spend (POAS): Profit lift generated per $1 (or other unit of a fiat currency) spent by a brand on a property sponsorship As an illustrative example, a 2.30 POAS would mean that for every $1 (or other unit of a fiat currency) spent, the brand generates $2.30 of incremental profit.

Target POAS: Brand's goal for profit lift that should be generated per $1 (or other unit of a fiat currency) spent by a brand on a property sponsorship.

Predicted POAS: Predicted profit lift that would be generated per $1 (or other unit of a fiat currency) if spent by a brand on an unsponsored property. In some embodiments, future POAS can be predicted for a sponsored property.

Recurring Customer Profit Lift: The difference in profit during the sponsorship period from recurring customers exposed to a property compared to recurring customers that were not exposed to the property.

Recurring Customer Profit Lift: The difference in profit during the sponsorship period from recurring customers exposed to a property compared to recurring customers that were not exposed to the property.

ROAS: the return on advertisement spend (e.g., the gross sales generated per unit of fiat currency spent) for a property. As an illustrative example, a 2.30 ROAS means that for every $1 spent, the brand generates $2.30 of incremental sales.

New Customer Net Profit: The profit from customers who made relevant purchases after being exposed to the property but did not make relevant purchases prior to the sponsorship, minus the profit lost from customers who made relevant purchases before the sponsorship but did not make relevant purchases after being exposed to the property.

Net New Profit: The profit from customers who made relevant purchases after being exposed to the property but did not make relevant purchases prior to the sponsorship, minus the profit lost from customers who made relevant purchases before the sponsorship but did not make relevant purchases after being exposed to the property.

It is appreciated that the above definitions are utilized in terms of revenue in the examples described herein. The following are additional terms (or explanations of aforementioned terms) that are mentioned herein:

Assisted Sales: Retail sales of an exposed audience, which is the revenue influenced by a sponsorship.

Sales Lift/Incremental Sales: Sales For exposed Customers+Food Service GM compared to sales of unexposed returning customers.

Lift %: Lift calculations are performed using a difference in difference method. The difference between the exposed and unexposed group's spend is calculated in both the pre- and post-periods. Then, the pre-period difference is subtracted from the post-period difference as to not inflate the post-period difference. The result is the intervention effect. This adjusted post-period intervention effect is then divided by the exposed average household spend in the pre-period and the result is the lift percentage or ‘Lift %’.

Investment: Sponsorship Spend+Activation Dollars

Food Service GM: Food Service Gross Margin generated by a brand from in-stadium sales during the exposure period.

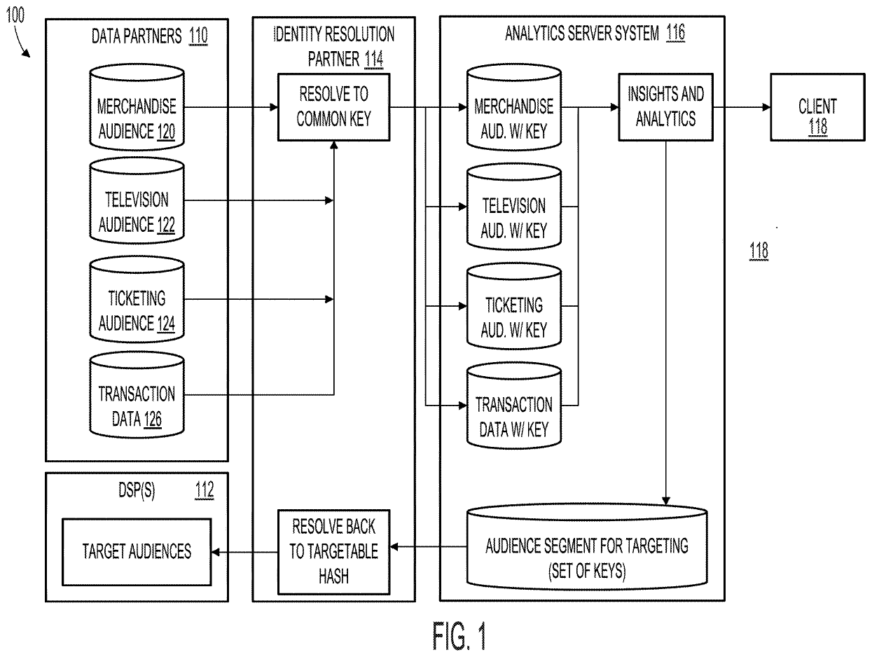

FIG. 1 shows an illustrative example of a system 100 for exchanging data over a network, which implements a data platform for determining sponsorship audience and tracking metrics related to lift in sales for advertisements, among other types of metrics in accordance with at least one embodiment. The system 100 includes a client device 118 that hosts a number of applications and is communicatively coupled to other servers via a communications network (e.g., the Internet, etc.). As further illustrated therein, system 100 includes data partners server 110, identity resolution partner server 114, and analytics server system 116.

Data partners server 110 includes various databases 120-126 storing data associated with respective audiences that provide data utilized by analytics server system 116. As illustrated in FIG. 1, data partners server 110 includes a merchandise audience database 120, a television audience database 122 (which can also include audience data for streaming services or other media services in some embodiments), ticketing audience database 124, and transaction data 126. In an embodiment, the data partners service 110 can further include databases corresponding to online, social, virtual reality, augmented reality, and/or location-based audience data.

The merchandise audience database 120 may include data corresponding to user activity such as online purchase transactions, product or item information (e.g., purchase price, particular sports team, sports league, individual athlete, and the like), user identifier(s), electronic messages (e-mails, and the like), device information, location information (e.g., shipping address, and the like), and other appropriate information or metadata associated with such purchases or user activity. The television audience database 122 includes information related to activity regarding TV program, viewing information (e.g., indicating every second of every program that a user is viewing), whether a user changed the channel, recorded and watched a DVR version of the program, and the like. The ticketing audience database 124 includes data for ticket purchases for each person at a live event (e.g., through a given ticket sales vendor or ticket distribution entity). Transaction data 126 includes information related to daily purchases of a particular household (UPC, product information, quantity information, amount spent or merchant name, quantity information, and amount spent). Other databases (not shown) can include mobile data information providing geolocations of customers based on mobile devices such as smartphones, and the like, that corresponding to a particular venue (e.g., stadium, event location, etc.), and different digital signals indicating online activity (e.g., visiting a particular website) associated with a particular sports team or event. The aforementioned data can be provided in a real-time, constant, or periodic manner to reflect updated information over the passage of time, which can be provided to identity resolution partner server 114, as described in greater detail herein. In some instances, the aforementioned data can be provided in response to a triggering event. For example, the data partners server 110 may automatically provide data from the databases 120-126 upon receiving a threshold amount of data. As another illustrative example, the data partners server 110 may automatically provide the aforementioned data in real-time as any new data is received.

In an embodiment, the data partners server 110 is an external server (e.g., a third-party server that serves as a data partner, etc.) that automatically collects the aforementioned data and provides the aforementioned data to the identity resolution partner server 114. Although data partners server 110 is shown as a single system, it is appreciated that in at least one practical implementation, each database 120-126 shown can be provided in its own respective system (e.g., cloud storage system, and the like). In some instances, one or more databases 120-126 may be implemented by one or more external entities (e.g., other servers, other third-party data brokers, etc.) that may collect, aggregate, and store data therein for use by the data partners server 110.

In an embodiment, the identity resolution partner server 114 receives data from the aforementioned databases 120-126 of the data partners server 110 and automatically removes any personally identifiable information (PII) (e.g., e-mail addresses, mobile identifiers, etc.) from such data, resolves the remaining data to a common key (e.g., replacing any PII with the common key), and then provides this data to analytics server system 116 so that the common key can be associated with the various data from the aforementioned databases of the data partners. Such a common key is utilized by the analytics server system 116 for producing analytics associated with the common key. Each common key can therefore be associated with a particular household (e.g., where multiple customers can be included in a given household or associated with a common payment type such as a credit card), and based on the common key the analytics server system 116 generates analytics and insights, such as through statistical analysis involving joining disparate datasets based on the common key and utilizing the combined attributes to determine detailed audience segments of interest to a brand.

In an embodiment, a common key is automatically generated by the identity resolution partner server 114 and may uniquely, or substantially uniquely, identify a particular household. As an example, the common key may be a string of alphanumeric or other special characters (e.g., “.”). In an embodiment, the common key is a universally unique identifier (UUID), which may also be referred to as a globally unique identifier (GUID). A UUID may be generated using any suitable technique for generating a unique identifier. A UUID may not be mathematically guaranteed to be unique, but may have a probability of being not unique that is low enough to be considered unique within the context of different households. As an example, the UUID generated by the identity resolution partner server 114 may be a version 4 UUID, which includes thirty-two hexadecimal characters representing 128 bits. In one or more embodiments, the bits that comprise the version 4 UUID are randomly generated. Therefore, there are 2128 possible combinations of bits, leaving the probability that two such generated UUIDs are the same very low within reasonable time and computation power constraints. Any other technique for generating a UUID may be used without departing from the scope of embodiments described herein.

In an embodiment, based on common keys (e.g., that resolve to particular user devices, households, and the like), the analytics server system 116 may determine audience segments. For example, based on the common key, analytics server system 116 can form an audience segment for fans of a particular sports team located within a particular geolocation (e.g., zip code, neighborhood, town, county, etc.) that can be targeted by advertisements from a particular brand. This audience segment information is then provided to identity resolution partner server 114, which then can resolve the audience segment information to a particular user device(s), IP address, or other information that is targetable with an advertisement. When segments are targeted in this manner, the sales impact can be determined by analytics server system 116 and provides a way for advertisers to get more value from their expenditures from sponsorships. Furthermore, the sales impact reporting is an enhancement to the current practice mechanisms such as surveys that often rely on what people say or feel but not what they actually do or media valuations that convey the media equivalency of media exposure but do not indicate the true impact on sales.

Identity resolution partner server 114 may provide such targetable information to demand-side platform(s) 112, which provides a system that allows buyers of digital advertising inventory to manage multiple ad exchange and data exchange accounts through an interface. Such a demand-side platform is used by advertisers to buy mobile, search, and video advertising from an online marketplace on which publishers list advertising inventory and thereby enable advertising in a programmatic or automated fashion.

The analytics server system 116 provides server-side functionality via the network to a particular client device 118. The analytics server system 116 supports various services and operations that are provided to the client device 118. Such operations include transmitting data, receiving data, and processing data, and the like. Data exchanges within the system 100 are invoked and controlled through functions available via user interfaces (UIs) of the client device 118 (or another client device). In an embodiment, the UIs implemented by the analytics server system 116 are hosted via a web server controlled by the analytics server system 116 and that can communicate with other internal application programming interfaces (APIs) and information systems to retrieve and dynamically present processed information.

Client device 118 is able to communicate and exchange data with analytics server system 116 via the communications network. The analytics server system 116 includes functions (e.g., commands to invoke functions) as well as payload data (e.g., text, audio, video or other multimedia data, and the like). In an example, client device 118 corresponds to a purchaser of advertisements and utilizes analytics server system 116 to track sales and other analytics associated with their advertising expenditures (e.g., in a given advertising campaign).

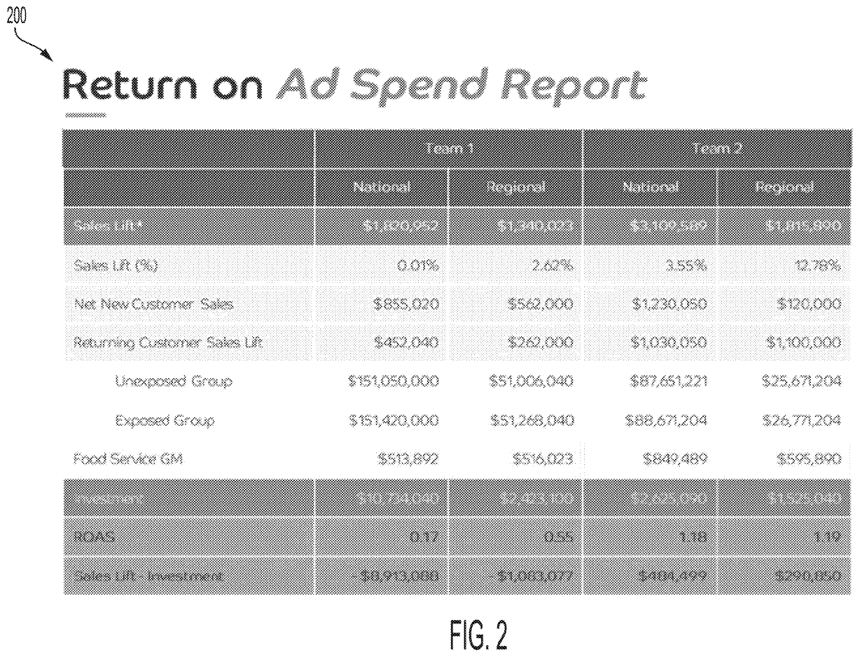

FIG. 2 shows an illustrative example of a chart 200 illustrating an example of ROAS from a sponsorship or group of sponsorships of sports properties in accordance with at least one embodiment. In the example of FIG. 2, the analytics server system 116 provides this information to client device 118 which can display the information as output for display on the client device 118. As illustrated in FIG. 2, the chart 200 provides various values for a ROAS in a given sponsorship or group of sponsorships of sports properties. For example, chart 200 includes respective rows of data including sales lift, net new customer sales, returning customer sales lift, unexposed group, exposed group, and food service GM generated by brand from in-stadium sales during an exposure period. As further shown, a row for investment, ROAS, and sales lift minus investment are included. In an embodiment, sales lift in the upper portion of chart 200 is determined based on a sum of values for net new customer sales, returning customer sales lift, and food service GM.

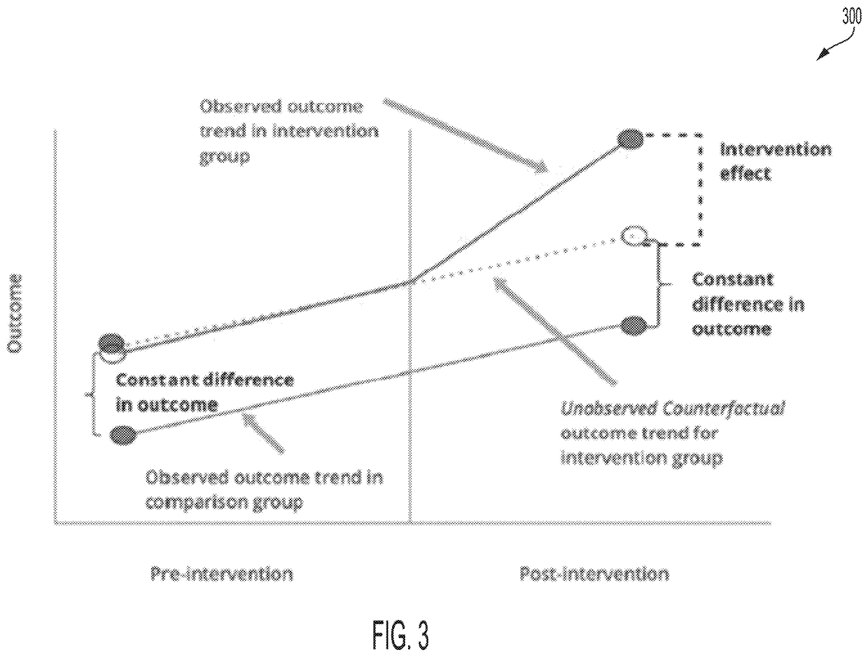

FIG. 3 shows an illustrative example of a chart 300 illustrating an existing example of determining lift calculations in accordance with at least one embodiment. The lift calculations described herein are performed by the analytics server system 116 described above and illustrated in FIG. 1. These lift calculations may be triggered by a user (e.g., a client device 118) using all available information, at regular intervals based on data availability, and/or on a subset of the data on demand and based on user needs.

In the chart 300, the difference between the exposed and unexposed group's spend is calculated in both the pre and post-periods. Then, the pre-period difference is subtracted from the post-period difference, as to not inflate the post-period difference (i.e., “difference in difference”). The result is the intervention effect. This adjusted post-period intervention effect is then divided by the exposed average household spend in the pre-period and the result is the lift percentage.

Chart 300, as illustrated in FIG. 3, illustrates a comparison between a control group and an exposed group where the control group is considered a “synthetic” control group or referred to as an unexposed group as mentioned herein. As mentioned above, a difference between a post-intervention value and a pre-intervention value is determined, which is then divided by the average household spend of the exposed group in the pre-period to determine a lift percentage value. Further examples of lift calculations are discussed in greater detail herein.

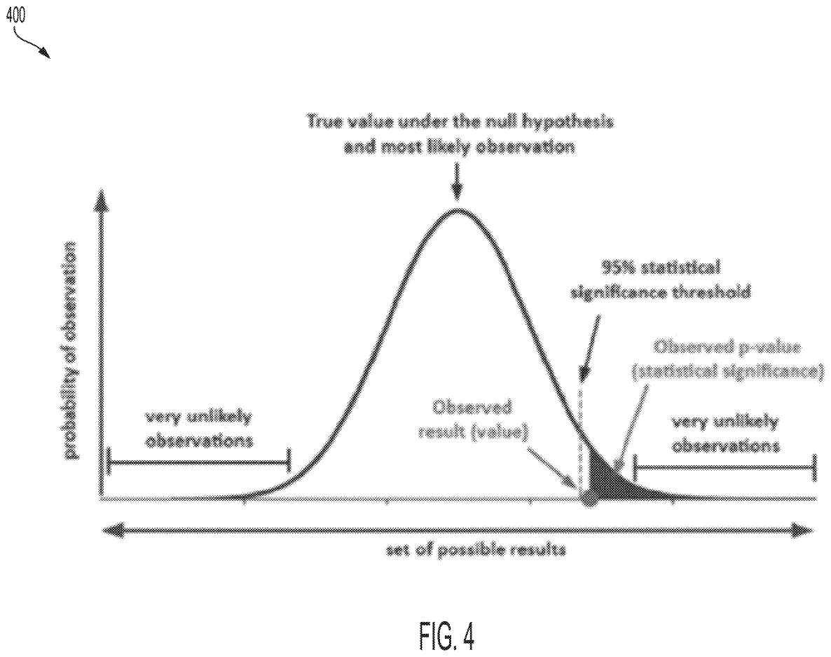

FIG. 4 shows an illustrative example of a chart 400 illustrating an existing example of hypothesis testing based on a t-test in accordance with at least one embodiment. In an example, a t-test is a statistical hypothesis test in which the test statistic follows a normal distribution or a t-distribution under the null hypothesis. As illustrated in FIG. 4, chart 400 illustrates an application of a t-test where the t-test determines the likelihood that an observed difference could be due to chance or could be an actual difference. The subject technology (e.g., the analytics server system 116) looks at sample size and distribution of data.

In chart 400, a probability of an observed difference is determined which indicates the likelihood that the observed difference is an actual observed difference. In chart 400, a value of a 95% statistical confidence is utilized. In existing traditional approaches, sales lift metrics are determined without using this statistical confidence resulting in less accurate sales lift metrics. Thus, the implementation of the t-test by the analytics server system 116 provides for more accurate metrics, such as sales lift metrics described herein.

If a brand's promotion (e.g., sponsorship or group of sponsorships of sports properties) did not actually affect spending behavior, then the population means between the unexposed and exposed groups would be the same. Therefore, any observed difference between the means could be due to random chance. The probability of this occurrence is given by the t-test. If that probability is less than 5%, then the hypothesis can be rejected that a promotion (e.g., sponsorship or group of sponsorships of sports properties) had no effect on the exposed group. Further discussion of utilizing a t-test is provided herein.

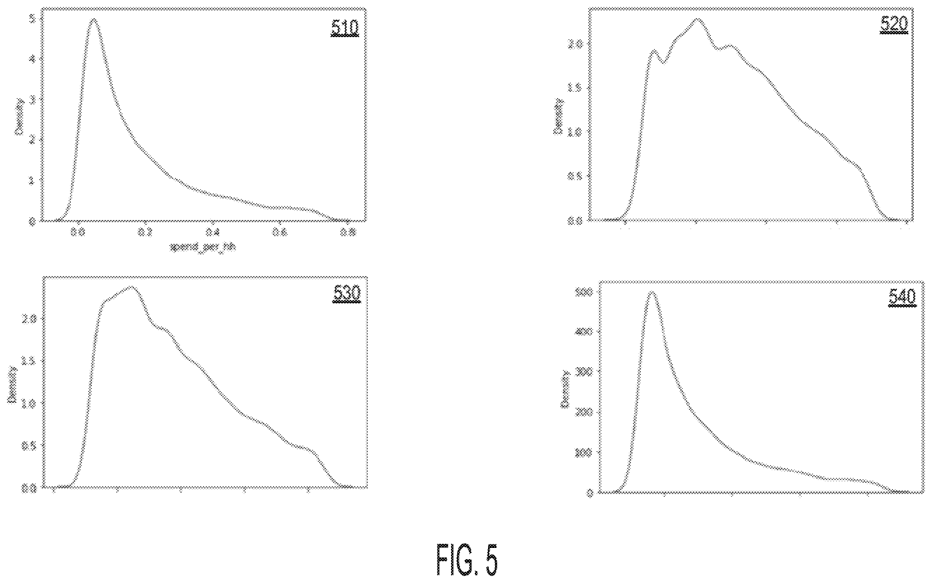

FIG. 5 shows illustrative examples of charts 510-540 illustrating various data transformations corresponding to data (e.g., spending data) that does not follow a normal distribution in accordance with at least one embodiment. Data utilized by the subject technology (e.g., spending data shown in chart 510) may not follow a normal distribution that, when graphed, corresponds to a bell curve. For example, spending data for a given product may not follow such a normal distribution as illustrated in chart 510. In chart 520, a data transformation using a square root function is shown. In chart 530, a data transformation using a cube root function is shown. In chart 540, a data transformation using a natural logarithmic function is shown.

In the embodiments illustrated in FIG. 5, data is transformed to a near-normal distribution and statistical confidence tests (such as the aforementioned t-test) are performed on the transformed data. These statistical confidence tests are performed in the near-normal distribution to provide lift numbers that are statistically significant at the p<0.05 level. In an embodiment, the transformed data is subsequently back-transformed to the original scale corresponding to the selected fiat currency (e.g., United States Dollar, Euro, etc.) before lift numbers are calculated. These data transformations are described in greater detail herein.

In an illustrative example of techniques for using statistical confidence and performing data transformations (as initially described above in connection with FIGS. 4 and 5), the control group may be comprised of people who did not buy any merchandise for the first or second sports teams since a pre-defined starting period (e.g., 2016, etc.) and who were not exposed to any company promotion in the pre-period, including various sport league sponsorships (e.g., NFL, NBA, MLB, MLS, and the like). In order to run statistical confidence tests, for example, a right skewed, bell-curved data per brand, team, region, season, channel and exposed/control groups is transformed into a near-normal distribution using the natural logarithmic, square root, or cube root transformations (as the distribution of the data dictates). For example, in an embodiment, the analytics server system 116 transforms the obtained data using the natural logarithmic, square root, or cube root transformations. The analytics server system 116 may evaluate each of these data transformations by comparing the means of the resulting data transformations according to an independent two-sample Welch's t-test or an independent two-sample Student's t-test (as the data may dictate) with a threshold of p<0.05. The first data transformation that crosses the p<0.05 threshold is selected for use. If the analytics server system 116 determines that none of the data transformations cannot pass the aforementioned p<0.05 threshold, the analytics server system 116 may automatically remove outliers from the corresponding data sets until the 99th percentile mark and the process described above is repeated to obtain a data transformation that satisfies the threshold.

For samples with statistically significant means, the analytics server system 116 transforms these means back to the original scale and performs lift calculations according to the aforementioned difference-in-difference method. The analytics server system 116 may subsequently take the difference between the average household spend between the exposed and unexposed groups in the pre-period from the difference between these groups in the post-period so that the post-period difference is independent of the pre-period difference. The analytics server system 116 may divide this adjusted post-period difference by the average exposed household pre-period spend to obtain the lift percentage.

In many situations, normal distributions are used to perform data experiments that result in reliable results. Normal distributions may occur naturally in many situations. As an illustrative example, in the realm of test scores, a few students may completely fail a test, a few students completely excel on the test, and the majority of students may score closely to the overall average test score. Similar patterns may occur in nature, such as in the height of the general human population.

An important property of the normal distribution may be the convergence to a mean value. For instance, if the sample data converges to a mean value, that mean value may be relied upon as a proxy for the mean of the larger population from which a sample is taken. If the data does not converge upon a calculated mean value, then this mean value may not be relied upon. Thus, as a given client device 118 may spend significant amounts of resources on sponsorships, the underlying data should yield a reliable mean without the introduction of bias to the experiment, particularly when removing any outliers from the data.

As noted above, data samples may not be perfectly normally distributed. Returning to the earlier illustrative example of human population heights, if a data sample taken from the overall data corresponding to human population heights is truly random, the data sample may be skewed to include taller or shorter people more so than people of average height but may still be approximately normal.

Returning to the data illustrated in the charts 510-540 of FIG. 5, where the modeled data is right-tailed and strongly skewed towards positive values, the data exhibits the general shape of the normal distribution. The data contained in the long right tail is present in the sample with very low density and is widespread in comparison to the spread of the rest of the data. This serves as an indication that the removal of the extreme data outliers and the transformation of the data to a near-normal distribution are both appropriate and likely to result in data transformations that have distributions that will more closely resemble the normal distribution. This allows the analytics server system 116 to rely upon the mean and to provide the client device 118 with data that it can rely upon when making advertising expenditure decisions.

In the example charts 510-540 provided in FIG. 5, the transformation of the data using the cube-root transformation function (as illustrated in chart 530) results in a near-normal distribution that provides the best results when compared to the other transformations performed by the analytics server system 116. Thus, the analytics server system 116 may use this data transformation to perform further analysis, as described above, and provide the results of this analysis to the client device 118.

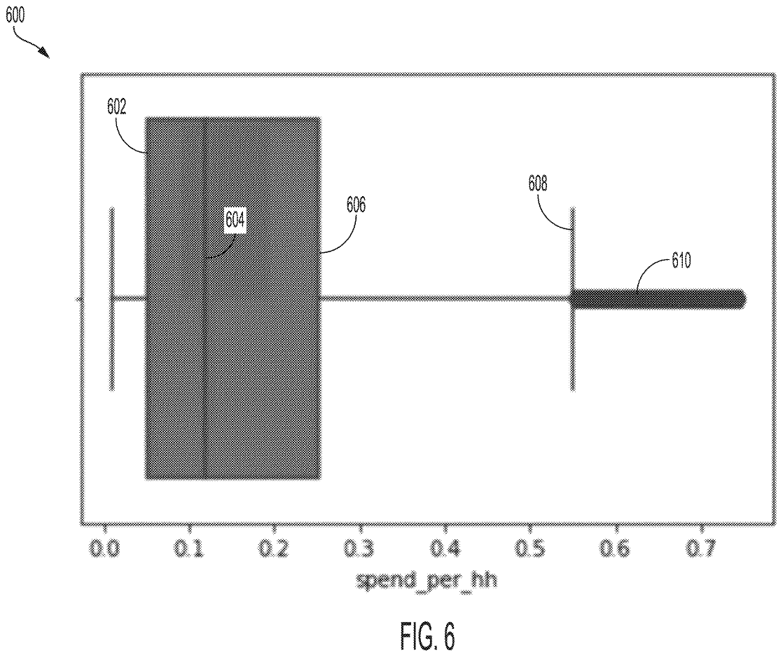

FIG. 6 shows an illustrative example of a chart 600 illustrating a box plot of data in accordance with at least one embodiment. The box plot of data illustrated in the chart 600 may be a standard plot in the study of a data set's distribution. In data experiments, results are optimized as the volume of data increases and as bias is removed from the data. Thus, the removal of any outliers may be performed conservatively, when necessary, in order to prevent the introduction of bias into the data while maintaining as much as data as possible.

In an embodiment, the analytics server system 116 first tests the data with any existing outliers. If the p<0.05 threshold described above is attained, the analytics server system 116 may forego removal of any outliers from the data in order to prevent introduction of bias into the data set. However, if the p<0.05 threshold cannot be achieved, the analytics server system 116 may remove any outliers in the right tail of the distribution. For example, the analytics server system 116 may define an outlier as a data value that is above 1.5 times the interquartile range of the data set. Thus, any data values that are above 1.5 times the interquartile range of the data set may be deemed outliers and automatically removed from the data set by the analytics server system 116.

In the box-plot illustrated in the chart 600, going from left to right, the edge of the box on the left side 602 marks the 25th percentile of the data set. The line contained inside the box 604 marks the median of the data. 50% of the data lies to the left of that mark and 50% of the data lies to the right of that mark. The edge of the box to the right of the median mark 606 marks the 75th percentile of the data. The difference between the left edge of the box and the right edge of the box is referred to as the “Interquartile Range”, denoted as “IQR” further herein. The mark to the right of the box in chart 600 (e.g., mark 608) denotes an accepted mathematical maximum of the data, which in the example provided in FIG. 6 is equal to 1.5*IQR. The line 610 in the chart 600 may denote the extreme outliers in the data set.

In the below block of programmatic code executed by the analytics server system 116, the IQR is calculated and the accepted maximum of the data set that may be deemed as “cutoff” is identified:

import pandas as pd
value_field_name = ‘spend_per hh’
df = pd.read_csv(‘spend_data_per_hh.csv’)
df_describe = (pd.DataFrame(df[value_field_name].describe( ))).T
IQR = df describe[‘75%’].iloc[0] − df_describe[‘25%’].iloc[0]
cutoff= df_describe[‘75%’].iloc[0] + (IQR * 1.5)
clean = df[df[value_field_name] < cutoff]

The data set denoted as “clean” is the data set visualized in the boxplot of chart 600 minus the data points represented by line 610. In the next round, data is tested with this very conservative removal of outliers. If the p<0.05 threshold is reached, no more outliers are removed from the data set. If p<0.05 is not reached with the extreme outliers excluded, additional outliers are trimmed in the right tail of the distribution. Due to the extremely long tail of distributions of spend data, the low density of the tail and the spread of the tail, removing additional data up to the 99^{th} percentile mark may be a conservative way to proceed.

In an embodiment, the analytics server system 116 removes outliers from the data set 0.01 units at a time and the threshold at the 99^{th} percentile mark is not crossed, as denoted in the following programmatic code:

max_threshold=np.percentile(clean[value_field_name],99)

After each round of removing outliers from the data set, the analytics server system 116 may perform the appropriate t-test, as described above, until the p<0.05 threshold is reached.

The aforementioned t-test may rely upon several assumptions. For example, the t-test may rely upon a bivariate independent variable, whereby two distinct groups are independent of each other. Furthermore, the t-test may rely upon a continuous dependent variable, which is not categorical (e.g., [‘red’, ‘green’, ‘yellow’], etc.). The t-test may also rely upon the assumption that each observation of the dependent variable is independent of the other observations of the dependent variable (its probability distribution isn't affected by their values). However, there is an exception to this, whereby for the paired t-test, it is only required that the pair-differences (Ai−Bi) be independent from each other (across i). Note that “independent” and “dependent” are used in two different senses here (e.g., a “dependent variable” as one thing, and “observations that are dependent” are another thing). The t-test may further rely on the assumption that the dependent variable has a normal distribution, with the same variance in each group (as though the distribution for group A were merely shifted over to become the distribution for group B, without changing shape).

In an illustrative example, the average household spend between the exposed and unexposed groups in each time period (pre-period and post-period) are compared. These two statistical groups are independent of each other so a two-sample independent t-test may be performed. The first three t-test assumptions are easily verified; no tests are necessary. Because a two-sample independent t-test is being performed, the final assumption can be rewritten as: each independent variable has a normal distribution, with the same variance within its own group and between the two groups.

The t-test is a test to determine whether the mean of one sample significantly differs (as opposed to randomly differs) from the mean of another, in which case any observed difference between them is meaningful. The t-test calculates the probability that this is not the case. For instance, if a client promotion did not actually affect spending behavior, then the statistical means between the unexposed and exposed groups would be the same and any observed difference between these means is just by random chance. The probability of this occurring is given by the t-test.

If the variance from the mean within each sample is low and the sample size is sufficiently high (as determined by the t-test), the probability that the means accurately reflect the population is high. Thus, the calculated means can be relied upon and the notion that one or both of the means were generated by chance can be rejected. Therefore, the observed difference between these means could not have occurred by chance.

The t-test is also a test of variability, best understood as deviation from the mean. The lower the variability the better because, with low variability, the data should converge upon a mean in order for the analytics server system 116 to rely upon it. The difference between the means, the variability of the sample data set and the size of the sample data set are used to calculate the t-statistic, or t-score. The t-score is a ratio of the difference between the two sample groups and the difference within each group. Ideally, the difference within the group is small (in other words, normally distributed) and the difference between the groups is large. A t-score of 2, for example, indicates that the two means are 2 times as different from each other than the difference within each group. To reiterate, in this case, the two groups are unexposed and exposed product purchasers and the greater population are shoppers in general. In this study, it is determined whether or not the treatment (e.g., the client promotion) had an actual effect on average household spend or if the observed difference is due to chance.

In an example, the analytics server system 116 calculates the probability, or p-value, that the means from the two samples are actually the same (meaning spending behavior was not affected by the company promotion) and that any observed difference happened by chance. If this probability is high, it would indicate that the promotion actually had no effect on spending behavior. If this probability is low, then the hypothesis that the average household spend between the two groups is actually the same and that the observed difference between the average household spend between the two groups is just random/by chance can be rejected. This is a hypothesis that the client promotion had no effect on the exposed group. As the two groups are independent of each other, a two-sample independent t-test is appropriate. If the variance between the two groups is equal, the Student's t-test is appropriate. If the variance between the two groups is not equal, the Welch's t-test is appropriate.

As noted above, the p-value is the measure of the probability that the means from the two samples are actually the same and that the observed difference happened by chance. This would indicate that the promotion actually had no effect on spending behavior. In an illustrative example, a threshold of p<0.05 (as used extensively herein) denotes that when the probability of the observed difference between the means is actually random/by chance is less than 5%, the notion that the difference between the means is random/by chance can be rejected. The observed difference is then attributed to the treatment (e.g., the client promotion).

In another illustrative example, a p-value of 0.08 indicates that there is an 8% change that the difference between the means is due to chance. This may still be significant. The p<0.05 threshold is the scientific standard that is adhered to in this example. However, in cases where the p-value is greater than 0.05 and less than 0.10, the corresponding results can be provided to a client device 118, along with the p-value.

In some examples, the strength of the p-values may be represented using asterisks, where p<0.10 may be denoted as “*”, p<0.05 may be denoted as “**”, p<0.01 may be denoted as “***”, and p<0.001 may be denoted as “****”, whereby lift numbers may be represented as 1.34%** (e.g., p<0.05), 3.56%**** (e.g., p<0.001), and the like. It should be noted that the strength of p-values may represented in different ways (e.g., colors, font sizes, font styles, other alphanumeric characters, other symbols, etc.) and the aforementioned use of asterisks should not be construed as a limiting example. A low p-value may provide confidence in the means and confidence in the observed difference, which allows the analytics server system 116 to provide client devices 118 with scientifically-based insights and results.

In an example, the closer the data is to the normal distribution, the more likely that the means actually converge upon the reported value and the less likely the mean is not representative of a true population. If the mean is, for example, an outlier of the population, the mean is unlikely to occur if the experiment were to be performed again. This may indicate that this mean arose from the data by chance.

In an embodiment, data transformations and the selection of the appropriate data transformation occurs according to the following operations. First, the data is transformed to a near-normal distribution using the square-root, cubic-root, and natural logarithmic functions to create three distinct data transformations. For all three data transformations, the analytics server system 116 calculates the average spend per household, tests the data for equal variance, and selects a t-test according to the tests for equal variance. Subsequently, the analytics server system 116 may perform the selected t-test for each of these data transformations with any included outliers.

If the p<0.05 threshold cannot be reached with the included outliers, the analytics server system 116 may remove some of these outliers according to the conservative methodology described above to retain as much data as possible while removing enough outliers to maintain a near-normal data distribution. With each round of outlier removal, the analytics server system 116 may perform the selected t-test and the data transformation that yields the lowest p-value is selected. This ensures that the analytics server system 116 is manipulating the analysis by removing more outliers than necessary and then choosing the data transformation that provides the lowest p-value. As noted above, the analytics server system 116 may remove outliers from the corresponding data sets until the 99^{th} percentile mark and the process described above is repeated to obtain a data transformation that satisfies the threshold. Once a data transformation is selected, the analytics server system 116 may back-transform the average spend per household to the original scale.

Once the t-test is performed and the test indicates that the means are significantly different from each other, these statistically significant means can be used by the analytics server system 116 to calculate lift. As noted above, to perform the t-test, the analytics server system 116 transforms the data according to a square root, cubic root, and/or natural logarithmic function. The analytics server system 116, in an embodiment, back-transforms the data to the original scale according to the mathematical inverse of the function used to perform the original data transformation. For example, the mean obtained by the analytics server system 116 using data transformed using a square root function may be squared (i.e., raised to the second power). As another illustrative example, the mean obtained by the analytics server system 116 using data transformed using a cubic root function may be cubed (i.e., raised to the third power). As yet another illustrative example, the mean obtained by the analytics server system 116 using data transformed using a natural logarithmic function may by transformed by taking the inverse of the natural log of the mean (i.e., raising e to the power of the mean). Because standard deviations are compressed within a logarithmic transformation, the analytics server system 116 may perform an additional adjustment to complete the back-transformation. The below example programmatic code may be executed by the analytics server system 116 to verify the accuracy of the back-transformation with this adjustment.

#sample data
test_list = [.5474,.693,.033]
df_test = pd.DataFrame(test_list, columns = [‘nums’])
real_mean = df_test[‘nums’].mean( )
#transform the data
df_test[‘log’] = np.log(df_test[‘nums’]+100)
#calculate statistics to transform the data back
m = df_test[‘log’].mean( )
v = np.var(df_test[‘log’])
#and transform it back
back_transformed_mean = (np.e**m)−100+(0.5*v)
#now, compare the mean of the original data set to
#the mean of the data that was transformed and then transformed back
print(real_mean)
print(back_transformed_mean)

In an embodiment, the analytics server system 116 performs lift calculations using a difference in difference method. The analytics server system 116 calculates the difference between the exposed and unexposed group's spend in both the pre- and post-periods. Subsequently, the analytics server system 116 subtracts the pre-period difference from the post-period deference so as not to inflate the post-period difference. The result is the intervention effect. This adjusted post-period intervention effect is then divided by the exposed average household spend in the pre-period and the result is the lift percentage.

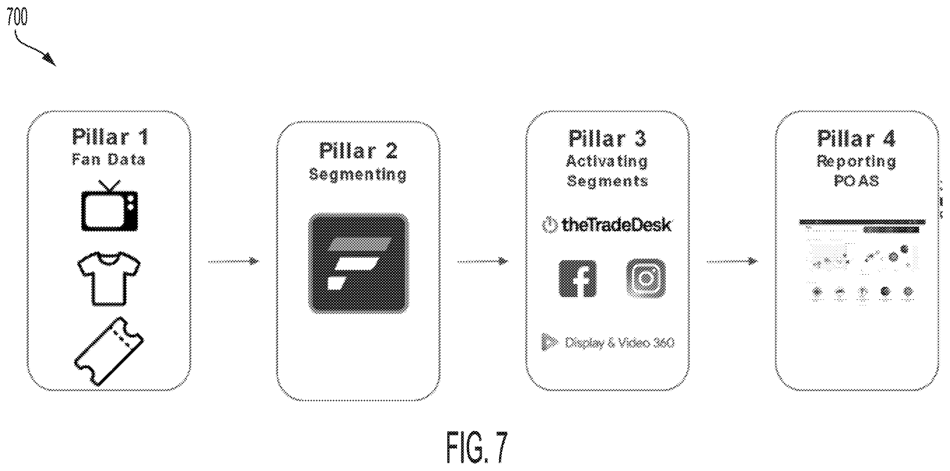

FIG. 7 shows an illustrative example of a data flow 700 for audience targeting and attribution in accordance with at least one embodiment. In the embodiments described herein, it is appreciated that techniques for attribution are separate from audience targeting. In an illustrative example, attribution can be understood as techniques that are implemented to determine a value of a given sponsorship based on changed in spending for exposed audiences. Brands (e.g., clients) have an opportunity to message fans using 1-to-1 direct messaging, increase impression frequency, and achieve greater overall reach. To make this happen, the sports world needs access to better “fan data” and until now, brands have mostly had “generic segments” (e.g., football fans, etc.) available via various data management platforms (DMPs). Stated another way, brands could customize campaigns to each fan as a result of the brands having information about the fan such as residence information (e.g., city, region, etc.), whether the fan likes a particular team or athlete, whether the fan has a certain avidity, and the like.

However, for sports sponsorships to be effective in a programmatic setting, there needs to be scale and custom segmentation. In an embodiment, the analytics server system 116 combines a number of data sets into a unified identifier (i.e., a common key, as described above) allowing brands to target fans of choice, with relevant messaging, where such messages can be further customized per fan basis, no matter how specific. As an illustrative, but non-limiting example, the combined data sets can be used to target fans of a particular athlete in the Pacific Northwest region of the United States. With the increased impression frequency, larger unique/addressable audience, and longer exposure period, brands have an opportunity to drive a larger and longer lasting impact on sales through their association with sports, beyond the traditional sports marketing assets that come from sponsoring a sports property. The result is ultimately to drive incremental sales from fans who were exposed to the campaign compared to a control group.

In some instances, it may be difficult to quantify success in terms of return on ad spend (ROAS) or profit on ad spend (POAS) for performance-based sponsorships using existing approaches. However, embodiments of the subject technology enable quantifying success in terms of ROAS or POAS for performance-based sponsorships. As discussed above in connection with FIG. 1, data from respective sources (e.g., merchandise audience data, television audience data, ticketing audience data, transaction data, etc.) can be provided by corresponding data partners servers 110. Although each data set, individually, is useful, a data set by itself can lack potential scale and addressability for client devices 118. Embodiments of the subject technology address this by combining numerous data sets together into a common key that enables scale and addressability for client devices 118.

As illustrated in FIG. 7, data flow 700 is split into 4 distinct pillars. As mentioned above, numerous data sets are unified into one common key that can then be activated across various platforms whether it be a DSP, social media networks, and the like. Returning to an earlier illustrative example, each common key can be associated with a particular household (e.g., where multiple customers can be included in a given household or associated with a common payment type such as a credit card). Thus, different data sets that are associated with a common key corresponding to a particular household can be unified according to the common key. The common key can be activated using other common keys, such as device identifiers, mobile advertising identifiers (MAIDs), Internet Protocol (IP) addresses, other customer segments (e.g., demographic information, geographic location, affinity signals, etc.), and the like. It is appreciated that an example DSP and social media networks are shown in FIG. 7, but should not be construed as limiting the subject technology and any appropriate platform can be utilized.

In an example, programmatic sponsorship can be a standalone solution but when combined with audience targeting and attribution, the subject technology is enabled to provide the incremental revenue generated from each campaign. The above examples are also applicable to unsponsored property measurement and targeting with respect to audience targeting and attribution. Instead of focusing on existing sponsorships for a client brand, the subject technology can identify potential targets (e.g., respective properties) that do not have current sponsorships in connection with the client brand and reach the unsponsored audience without a formal sponsorship, but without leveraging sometimes costly marks/intellectual property, that are reserved for an official sponsorship.

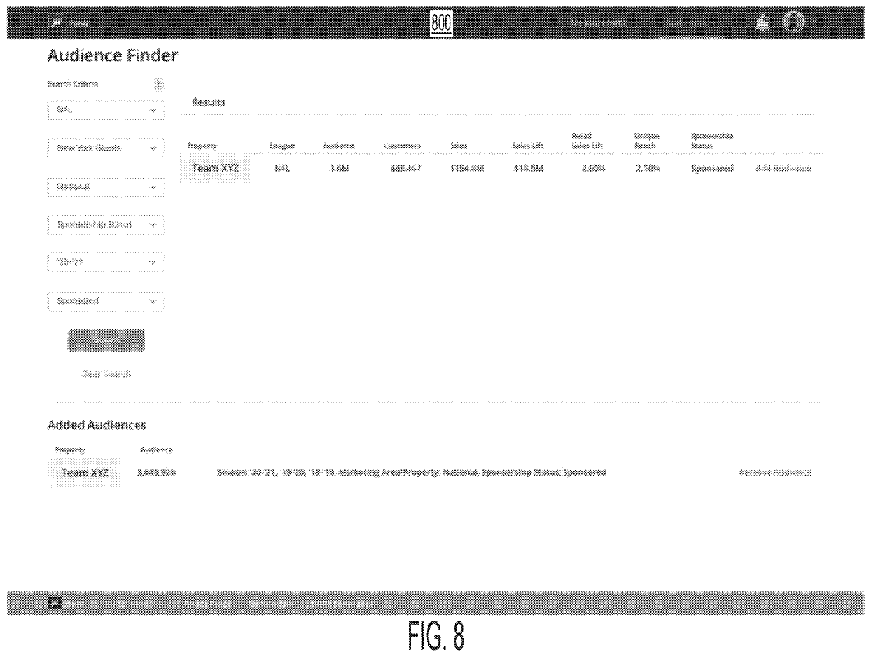

FIG. 8 shows an illustrative example of a user interface 800 in accordance with at least one embodiment. The interface 800 represents an audience finder that can be used by a client device 118 to facilitate audience targeting and attribution, and utilize data set unification as described above in connection with FIG. 7. For example, interface 800 includes various graphical items to specify or select specific search criteria. Interface 800 also includes a graphical item to add a particular audience and a graphical area (e.g., in the lower portion) to display an added audience.

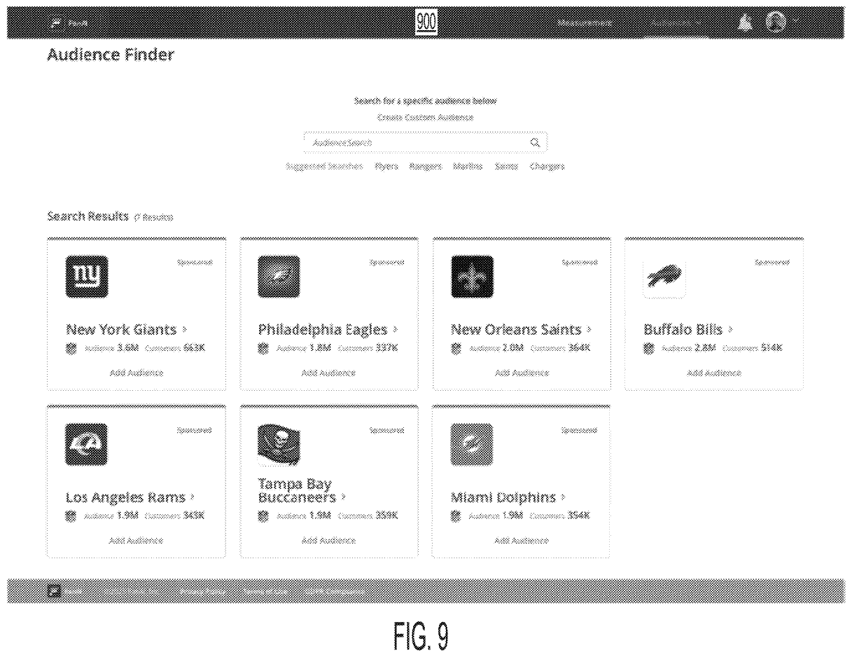

FIG. 9 shows an illustrative example of a user interface 900 in accordance with at least one embodiment. The interface 900 represents an audience finder including an input field for search terms for a particular audience. As illustrated in FIG. 9, search results are included in the lower portion of interface 900. Through the input field, a user (e.g., a client device 118) may input one or more search terms that may be processed by the analytics server system 116 to identify one or more common keys that may be associated with these one or more search terms. Based on these common keys, the analytics server system 116 may provide a set of search results corresponding to the one or more audiences (e.g., common keys) identified by the analytics server system 116 according to the provided search terms.

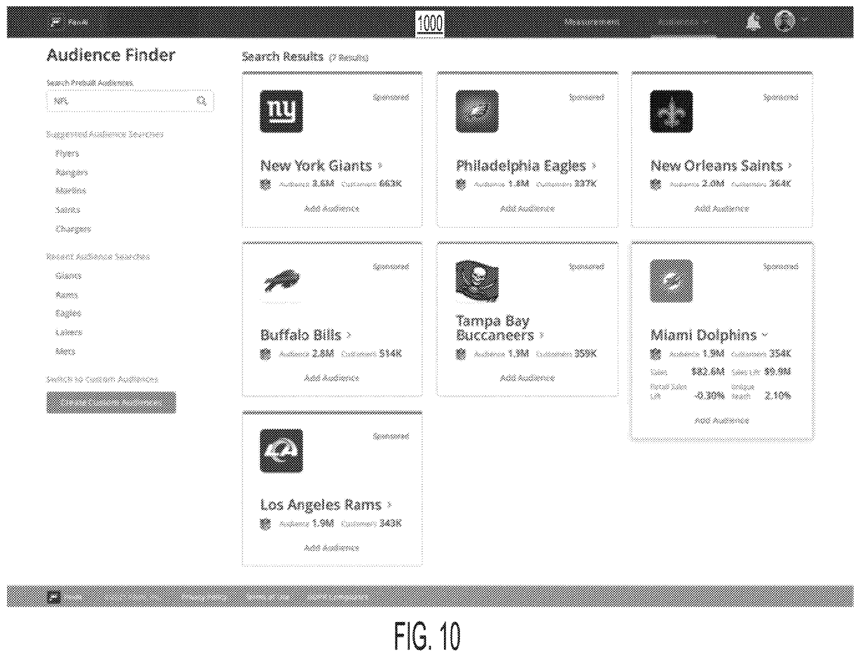

FIG. 10 shows an illustrative example of a user interface 1000 in accordance with at least one embodiment. The interface 1000 represents an audience finder including an input field for search terms for a particular audience. As illustrated in FIG. 10, search results are included in the right side portion of interface 1000. Similar to the user interface 900 described above in connection with FIG. 9, through the input field, a user (e.g., a client device 118) may input one or more search terms that may be processed by the analytics server system 116 to identify one or more common keys that may be associated with these one or more search terms. Based on these common keys, the analytics server system 116 may provide, through the interface 1000, a set of search results corresponding to the one or more audiences (e.g., common keys) identified by the analytics server system 116 according to the provided search terms.

As noted above, ticketing audience data can be received from a given data partners server 110 such as a ticketing vendor, and such data can be utilized to identify fans of a sports team that attend home and away games. Additionally, television audience data can be provided by a given data partners server 110 (e.g., broadcast platform, media recording service, and the like), which provides exact television viewing events of number of people within a given geographical area or country including the zip codes and metadata for each program (e.g., TV show, and the like). This enables finding the fans (e.g., persons or households) of any given team and also enables running studies on patterns of behavior like “fan avidity,” as discussed herein. In an example, data from a given data partners server 110 includes line-by-line purchases from households matched through the identity resolution partner server 114. In particular, such data includes columns for team, player, merch type, league, price, etc. In an embodiment, the subject technology resolves the aforementioned data to a single common key.

In some embodiments, the analytics server system 116 uses logo detection to track the sales impact of a specific asset by analyzing data corresponding to persons that are exposed to the asset (e.g., while viewing a broadcast or program). For example, logo detection is utilized as a filter with attribution (e.g., for asset specific metrics).

In an embodiment, the analytics server system 116 determines the true value of sponsorships by providing their impact on sales and providing clients with clear, actionable insights. When a client device 118 longs into the data platform provided by the analytics server system 116, the analytics server system 116 provides these insights at the forefront.

In an embodiment, the analytics server system 116 includes an insights engine that translates the raw data that is generated according to the techniques described herein into insights that are direct, meaningful, and easily consumable. For instance, using natural language processing (NLP) or other machine learning/artificial intelligence technique, insights engine may generate insights in the form of sentences or other human-readable structure that allows a user of a client device 118 to readily consume the provided insights. The insights engine may further populate pre-determined insights structures, built around client needs and business use cases, and automatically delivers these insights to the client device 118. In an illustrative example, such insights are provided as output that includes in an interface (such as any of the interfaces described above in connection with FIGS. 8-10). The insights engine may further provide automation that can be used to indicate specific actions that the client device 118 should take as a result of a provided insight. In some instances, the insights engine may use mathematical rules and/or machine learning/artificial intelligence techniques to separate high quality insights from lower quality insights derived from the audience data, so that only the highest quality (e.g., most interesting, most actionable, etc.) insights are displayed to clients.

In an implementation, a client may start by looking at overall property metrics and not specific activations or media channels. This would provide a brand client with insights they can use to help manage a whole portfolio of sponsored properties and help focus the client on the properties that require immediate attention. For example, this can include sponsored properties that are coming up for renewal within a particular time frame (e.g., next 12 months, next 6 months, next 3 months, etc.). This can further include sponsored properties that significantly changed in terms of POAS from the last evaluation period, including changes in POAS tier, changes in league ranking, changed in region ranking, and the like. For instance, a POAS tier change alert may be generated that indicates when a property has become less profitable and/or more profitable and allows a client to shift strategy as needed. As another example, the insights engine may generate a league performance change alert that is triggered when a particular property has changed more than five positions within the league rankings. As yet another example, the insights engine may define a regional performance change alert that may indicate a change of two or more positions within a regional ranking and, thus, may require a change in regional strategy.

As another illustrative example, the insights engine may provide a client with data corresponding to how many and which unsponsored properties would have a higher predicted POAS than an average POAS across a sponsorship portfolio that should be considered as an alterative investment. This information may be used to determine whether a client should continue allocating resources to new unsponsored properties. For instance, the insights engine may identify any unsponsored properties that have a projected POAS greater than two times the average POAS for sponsored properties and provide alerts for a pre-defined number of such properties (e.g., top five unsponsored properties, etc.). The insights engine may further identify the top performing sponsored properties that have a POAS greater than two times the average POAS for sponsored properties and provide alerts for a pre-defined number of such properties (e.g., top five sponsored properties according to POAS, etc.). Similarly, the insights engine may further identify the boom performing sponsored properties that have a POAS less than one-third (or other threshold fraction) the average POAS for all sponsored properties and provide alerts for a pre-defined number of such properties (e.g., bottom five sponsored properties according to POAS, etc.).

Such data may be provided by the insights engine based on different user prompts. For example, based on a provided prompt, the insights engine may evaluate a specific property to provide insights that may be used to determine whether to renew, renegotiate, or pull out of an existing sponsorship. Illustrative examples of such prompts may include (but are not limited to): “What is the POAS of the property relative to target POAS tiers?” “Compare to other SPONSORED PROPERTIES,” “Compare to other SPONSORED PROPERTIES in a specific REGION,” “Compare to other SPONSORED PROPERTIES in a specific LEAGUE,” “How many and which UNSPONSORED PROPERTIES would have a higher predicted POAS and should be considered as an alternative investment?” and the like.

As noted above, the insights engine may use NLP or other machine learning/artificial intelligence technique to generate insights in the form of sentences or other human-readable structure that allows a user of a client device 118 to readily consume the provided insights. As an illustrative example of a provided insight, the insights engine may provide the following output: “The [Sports Team] is a TIER [3] property and has been for the past [3 quarters]. The sponsorship cost [Company XYZ] more than 5× what [Company XYZ] made back in incremental profit. It ranks [12^{th}] overall in the SPORTS LEAGUE for incremental profit but [last] among sponsored properties in this league. In an example, consider the SPORTS TEAM 123 or SPORTS TEAM ABS as alternative investments that, with the same investment level, could increase POAS by up to [50%] and make this a TIER [2] investment.”

In an embodiment, the insights engine may define a number of POAS tiers based on incremental profit lift relative to POAS. For instance, a first POAS tier may correspond to properties that have an incremental profit that is greater than or equal to the corresponding investment made. A second POAS tier may correspond to properties where the investment was three times or more than what was made back in incremental profit. A third POAS tier may correspond to properties where the investment was five times or more than what was made back in incremental profit. It should be noted that the number of POAS tiers and corresponding defining metrics may be selected according to client utility and feedback provided with regard to any provided metrics and corresponding insights.

In an embodiment, a client can provide various inputs that can be used to configure the various metrics and insights provided based on available data. For instance, a client may configure the profit margin that is applied to the sales lift, the investment levels for sponsored properties, the target investment levels for unsponsored properties, the contract start and end dates, which markets/teams where Tier 1, 2, or 3 are acceptable, and the like. Based on such inputs, the insights engine may provide corresponding outputs (including relevant metrics and insights) that may be useful to the client.

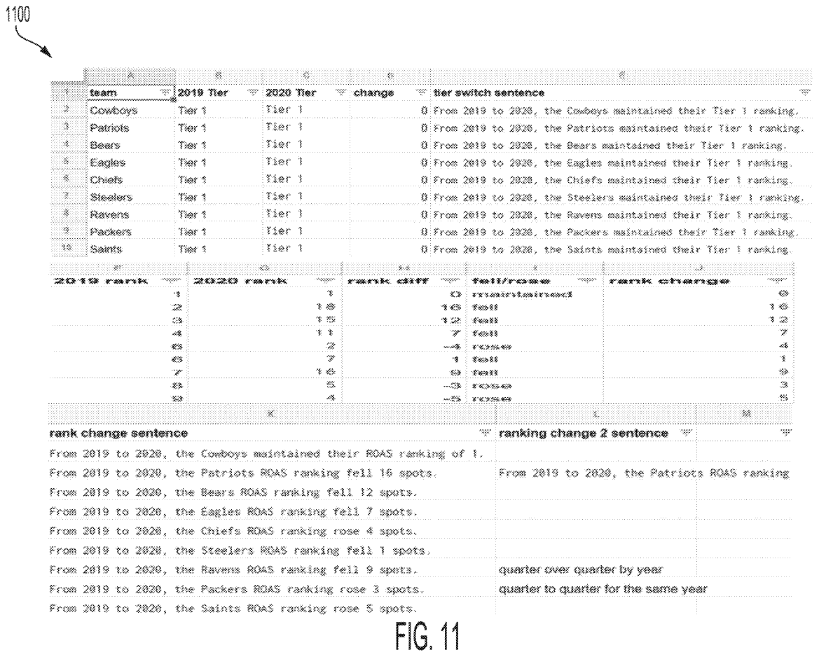

FIG. 11 shows an illustrative example of insights engine data 1100 in accordance with at least one embodiment. As illustrated in FIG. 11, insights engine data 1100 includes various columns corresponding to a team, tier for a first year, tier for a second year, change, tier switch sentence, rank for the first year, rank for the second year, rank difference, fell/rose indication, rank change, rank change sentence, and ranking change second sentence.

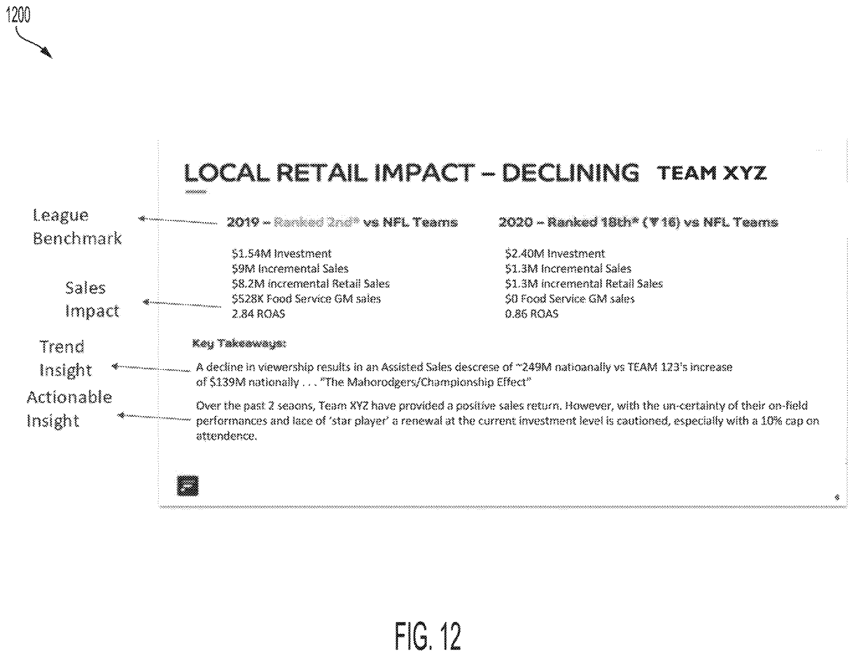

FIGS. 12-15 show illustrative examples of interfaces 1200-1500 for various insights engine data in accordance with at least one embodiment. As illustrated in FIG. 12, the analytics server system 116 provides, through the interface 1200, league benchmark data corresponding to a particular team (i.e., Team XYZ) over a period of time, highlighting the team's rank compared to other teams and any changes to the team's rank over this period of time. Additionally, the analytics server system 116 may indicate a sales impact over the period of time in terms of ROAS while providing any available investment and sales data. The analytics server system 116, as noted above, may generate and present, through the interface 1200, any trend insights based on the obtained data and corresponding actionable insights that may inform a client as to any actions they may take in order to improve investment efficiency.

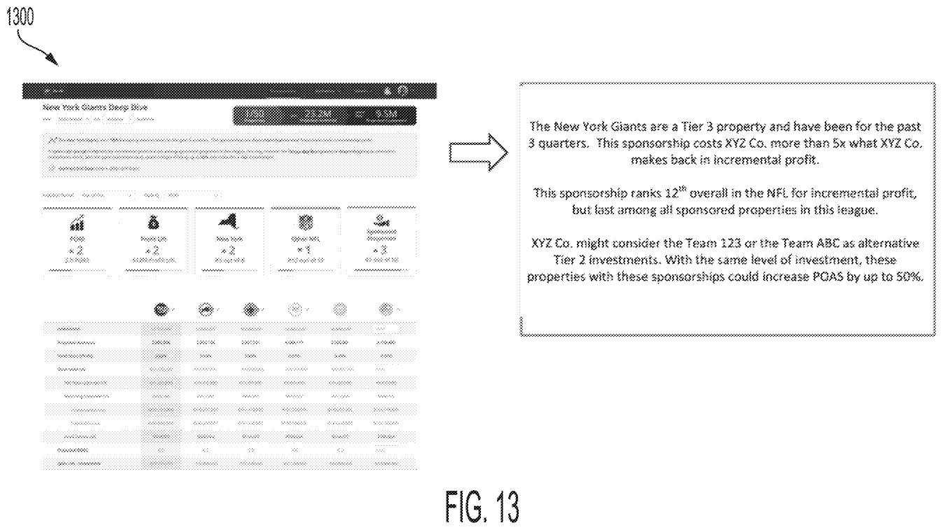

As illustrated in FIG. 13, the analytics server system 116 provides, through the interface 1300, provides benchmarking data for a particular property compared to other properties across different metrics (e.g., POAS, Profit Lift, etc.) and characteristics (e.g., region, league, etc.). A client, through the interface 1300 may compare, across different metrics, different properties to determine the performance of a given sponsorship and identify different sponsorship opportunities that may result in greater performance. In an embodiment, the analytics server system 116 generates and presents different insights based on the obtained benchmarking data and provide recommendations for investments that may provide greater returns compared to present investments in a given property.

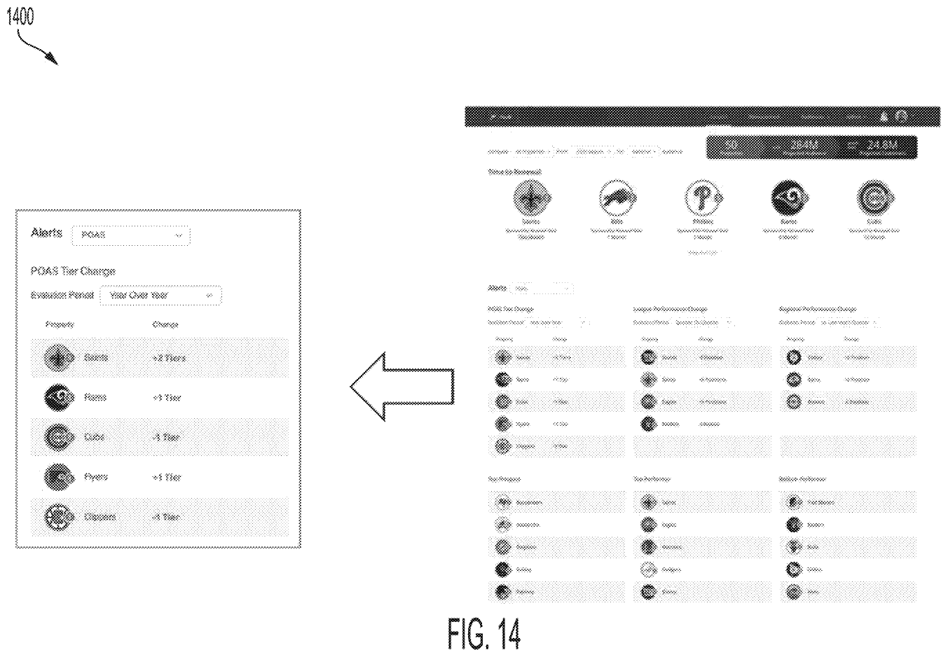

As noted above, the insights engine of the analytics server system 116 allows clients to configure POAS tier change alerts that may be implemented to indicate when a property has become less profitable and/or more profitable and allows a client to shift strategy as needed. The insights engine may further generate a league performance change alert that is triggered when a particular property has changed more than five positions within the league rankings. The insights engine may further define a regional performance change alert that may indicate a change of two or more positions within a regional ranking and, thus, may require a change in regional strategy. As illustrated in FIG. 14, the insights engine may provide, through the interface 1400, data corresponding to any tier, league performance, and regional performance changes for a given set of properties as selected by a client. As changes occur, the insights engine may provide alerts to the client according to the configuration of these alerts (whether by default or as defined by a client for a given set of properties).

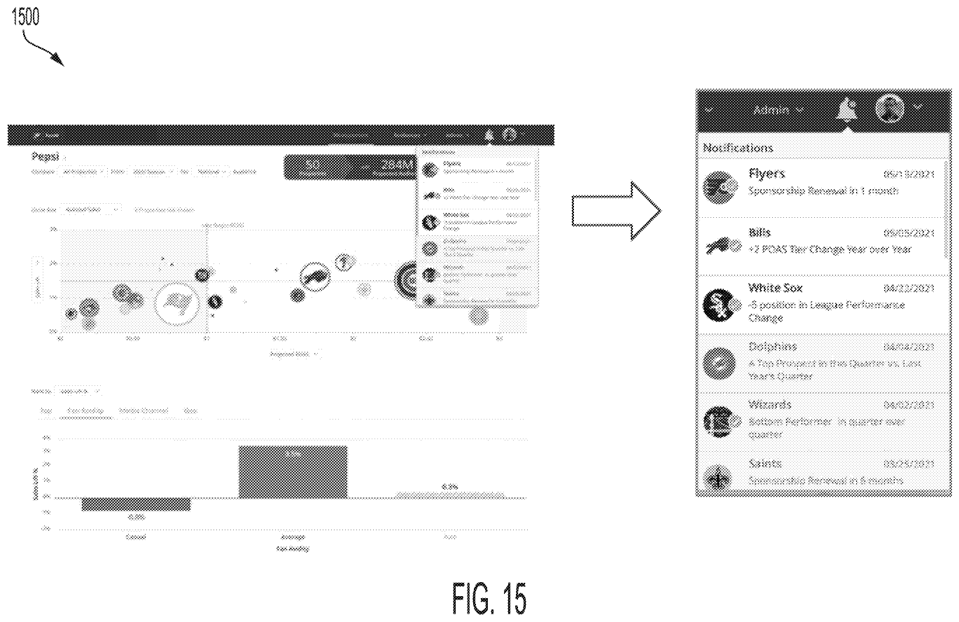

As illustrated in FIG. 15, the insights engine of the analytics server system 116 provides notifications and alerts corresponding to different sponsorship properties associated with a client. For example, through the interface 1500, the insights engine may notify a client as to any sponsorship actions that may be upcoming for different sponsorships (e.g., sponsorship renewals, etc.). Further, the insights engine may provide a client with different alerts corresponding to POAS tier changes, league performance changes, regional performance changes, and the like for different sponsorship properties implemented by the client. In some instances, the insights engine, through the notifications window provided through the interface 1500, may further provide insights regarding different investment opportunities that may be available to the client and that have a higher predicted POAS compared to existing sponsored properties. The insights engine may further provide insights into sponsored properties that are not performing according to desired benchmarks.

In an embodiment, the analytics server system 116 determines “fan avidity,” which is a way to classify a team's fans into appropriate categories, as the data may dictate. Embodiments of the subject technology consider TV audience sports programs, which include any program that is associated with a full_team_name in the TV audience dataset, be it a “classic game” from the 70s, an in-season game, or some kind of special program, as long as it is linked to a team and viewed within the time frame in consideration, as well as ticketing and merchandise data.

In an example, households are classified into four categories: sub-incidental (not to be reported), incidental, casual and avid fans, for each team for which they view a program, purchase merchandise and/or attend a home game. If a household has no indications of fandom for a team, they will receive a null value, upon which embodiments of the subject technology can coerce “non-fan”. In an example, a household can be classified into more than one bucket if they have viewed a program for more than one team. For instance, a household can be classified as including a casual fan of Sports Team ABC and Sports Team 123, and an avid fan of Sports Team XYZ.

Using descriptive statistics, the categories are interpreted to describe each group's behavior and conditions must be met to ensure that the groupings are: (1) distinct from each other; and (2) strong (e.g., the standard deviations within the groups are low). In an embodiment, a fan avidity score is calculated by the analytics server system 116 without human intervention and bias. Embodiments of the subject technology consider two types of scoring: percentile scores and normalized scores. Embodiments of the subject technology work with various sports leagues' (e.g., NFL, NBA, NHL, MLB, MLS, etc.) data for each league's season. Fan avidity is calculated for each team, for each season. While the exact dates of the start of a sports season vary by a few days year to year, each sports league always starts its season in the same month, year over year. However, the analytics server system 116 may further calculate fan avidity scores based on events associated with these sports leagues that may occur before, during, and/or after their seasons such as exhibition games, All-Star games, tournaments, pre-season games, and the like. Fan avidity for each season is calculated from a respective date in a year to the same date in a comparative year. In an example, avidity for a subsequent season would be calculated from the same date in the season in question to the same date in the following season and so forth. In an embodiment, there is no differentiation between home and away games since embodiments of the subject technology may not know why a person is watching a program. Thus, someone who is watching Team 1 vs Team 2 will get “credit” for watching both teams. TV audience Sports Program Data is summarized by household and league, calculating average number of programs watched and average number of hours watched (Dataset 1). This dataset produces the league benchmark. Although TV audience data is mentioned as an example, it is understood that other types of data can be utilized.

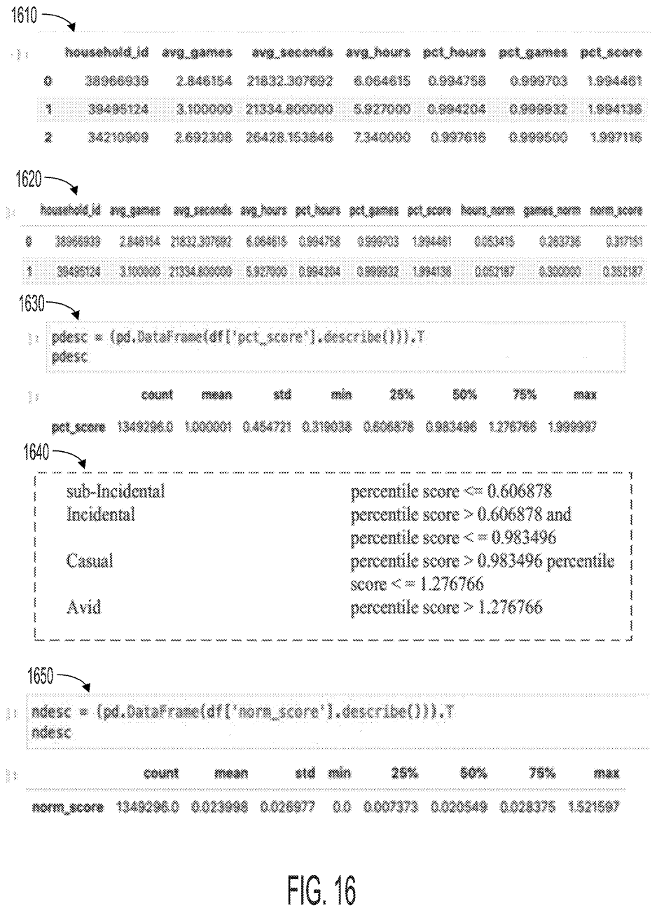

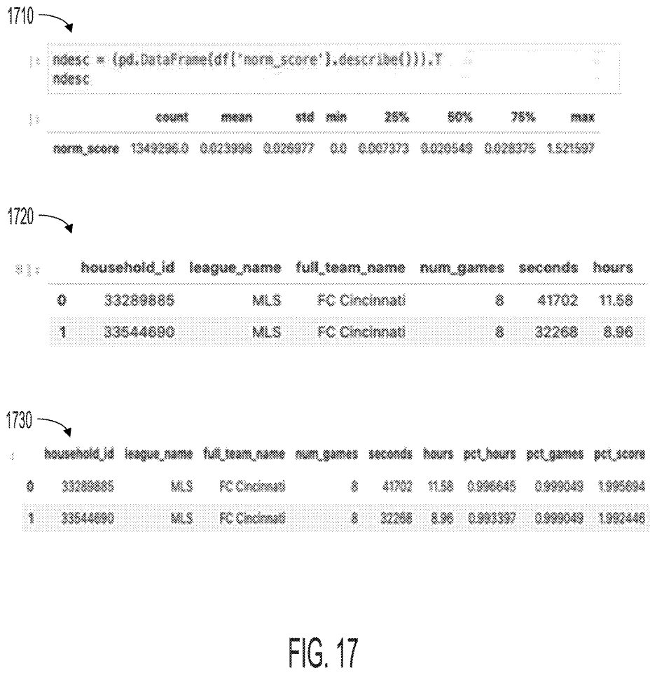

FIGS. 16-17 show illustrative examples of data in accordance with at least one embodiment. To calculate percentile scores, Dataset 1 is first analyzed and each household is ranked against all others for: (1) number of programs watched; and (2) amount of time watched (as measured in hours). Each household then receives two scores: a percentile for the number of programs and a percentile for the amount of time watched, with a minimum value of 0 and a maximum value of 1, for the 100th percentile. These two scores are added together to create one league avidity percentile score, on a 0 to 2 scale. Data 1610 illustrated in FIG. 16 provides an illustrative example of such data.

Data normalization is often applied when the data set to be analyzed contains variables with different scales. In an embodiment, programs watched and length of time watched are on different scales. For example, a household can watch 0 to 272 different NFL games during a season. Considering that an NFL game is approximately 3 hours long, if someone watched all 272 games, they'd watch for 816 hours. As these two variables are on very different scales, it's not preferable to create a fan avidity score without transforming the data first. Embodiments of the subject technology may utilize percentiles, and embodiments of the subject technology can also do so using data normalization.

In order to calculate these scores, the analytics server system 116 normalizes the data using the minimum-maximum method. Each data point is scaled using Eq. 1, where the minimum value is 0 and the maximum value is 1.

$$z = \frac{x - min ( x )}{max ( x ) - min ( x )} \qquad ( Eq . 1 )$$

Using the minimum and the maximum, the range of the data is preserved. This also creates an opportunity for high standard deviations within the fandom groups because of outliers. With this approach, Dataset 1 is first analyzed and two new variables are created: normalized values for total number of programs watched and hours watched. Then, the two scores, on equal scale, are added together to create a league avidity normalized benchmark with a minimum score of 0 and a maximum score of 2. As mentioned before, the normalization method preserves the range.

The percentile method described herein divides households into halves based on the median and into quarters based on the median of the halves, creating four groups of almost equal distribution. The normalization method makes no such distinction and, thus, will create groups based on chunks within the data. In terms of an example use case, the percentile method will produce four groups and the normalization method will also produce four groups. These four groups define a league benchmark where there is a definition of each group based on the data describing all of the sports programs associated with a given league, regardless of team. The method that produces the groups with the lowest standard deviation within the groups is the method that best divides the data into groups and the data will dictate that. Thus, the data will choose the method.

With both scores calculated, Dataset 1 for a select league is comprised of, for each household identifier (i.e., common key): the average number of hours watched of league-related sports programs, the average number of programs watched, the league avidity percentile score (pct_score), the league avidity normalized score (norm_score), and the sub-components of the aforementioned scores. An illustrative example of the aforementioned data is illustrated in data 1620 provided in FIG. 16.

With respect to bucketing, each league score is divided into 4 buckets, to create benchmarks for each fan avidity group. In an implementation, the cutoffs for the four groups are defined by taking the league benchmark and cutting it into four pieces, at the 25% markers. It is appreciated that, however, this is not like percentiles and is unrelated to the distributions of the data. Each of those cut-offs are league benchmarks for sub-incidental, incidental, casual and avid fans, respectively, and fans will fall into each category as they may. An example of cutoffs for the MLS's percentile score benchmarks are illustrated in data 1630 provided in FIG. 16. Further example data is illustrated in data 1640 provided in FIG. 16.

As illustrated in FIG. 17, the cutoffs for the MLS's normalized score benchmarks are illustrated in data 1710. TV audience Sports Program Data are now summarized by household and by team as illustrated in data 1720. The average number of programs watched per season and average total number of hours watched per season (per team) is calculated (Dataset 2). Percentile and Normalized scores are calculated by league and team are illustrated in data 1730. Then, the league benchmark from Dataset 1 is applied to each household/team combo in Dataset 2. Each household is assigned a classification of “sub-incidental”, “incidental”, “casual”, and “avid” fandom by team and by score. It should be noted that it is possible that a fan could be considered an avid fan of a team by one method and a casual fan of a team by another method. Then, descriptive statistics are produced to describe each category of fandom. For example, a casual fan watches two sports programs for 8 hours total, etc., as described in greater detail herein.

In an embodiment, to perform score selection, the analytics server system 116 chooses one method of scoring over another. Embodiments of the subject technology can expect a high level of variation within avid fans, because of outliers and embodiments of the subject technology need not consider sub-incidental fans, so embodiments of the subject technology only need to consider the incidental and casual fan groups. Taking the difference between the standard deviation within each group will point us in the right direction.

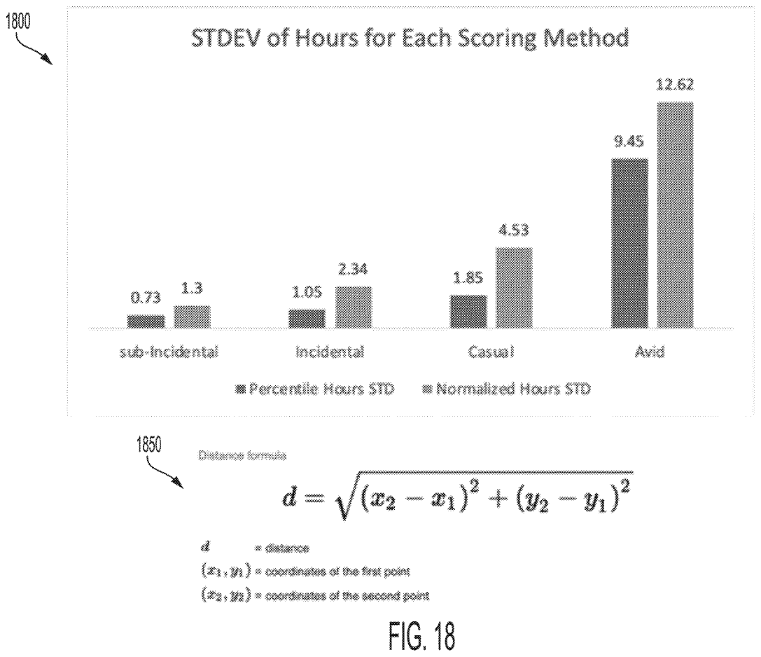

FIG. 18 shows an illustrative example of a chart 1800 and of a formula 1850 for fan avidity in accordance with at least one embodiment. As illustrated in the chart 1800, the difference in the standard deviation between the normalized method and percentile method for the casual group, 4.53−1.85=2.68. Considering that the metric is hours, this is a substantial difference. If the metric were programs, it would also be a substantial difference. This is an indication that the percentile method creates stronger groups.

If the standard deviations are very close between the two methods, then the next determination is made by looking at the difference between the groups. A ratio of 1 means that the standard deviations between the methods is equal. Defining “very close” as a ratio ≤1.1 is a logical choice, considering that the metrics are hours and number of programs. If the ratio of standard deviations for both the incidental and casual groups is low, embodiments of the subject technology are interested in how different the groups are from each other. This is as simple as calculating the distance between the groups. Let x=median hours watched and y=median number of programs watched and the distance between one group and another is calculated by distance formula 1850 in FIG. 18. Once the distance between each successive group is calculated, the total distance is summed and the method that provides fan avidity groups that are most different from each other is selected.

For each league and for each team, a household is assigned a fan avidity classification of sub-incidental (which is not reported), incidental, casual, avid or the value is null if the household did not view any programming for a team, which embodiments of the subject technology can coerce with “non-fan”. Embodiments of the subject technology need only report on incidental, casual and avid fans in the product.

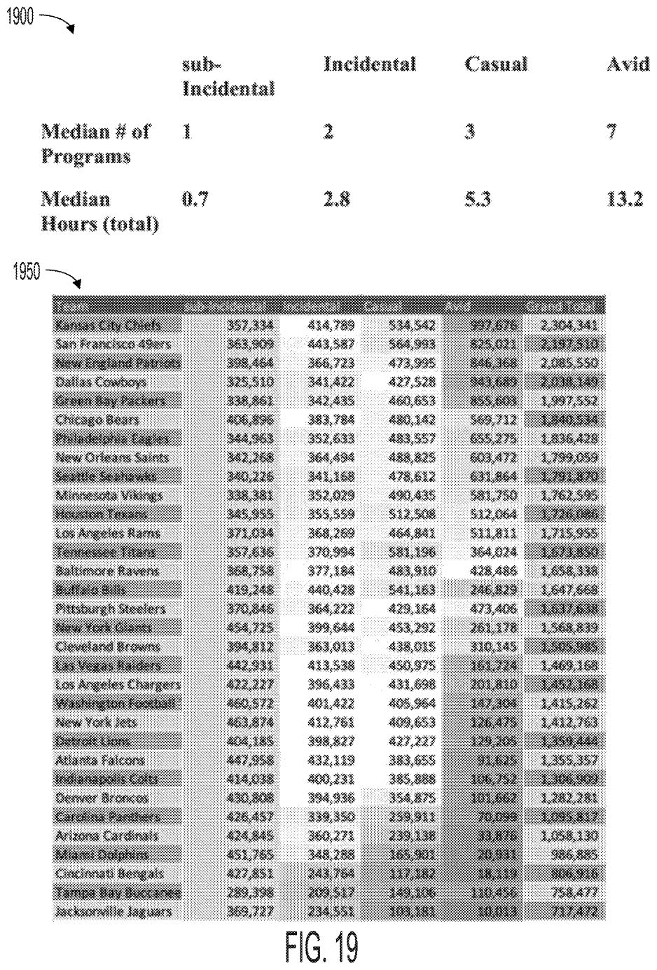

FIG. 19 shows an illustrative example of results 1900 and 1950 for fan avidity in accordance with at least one embodiment. Using the different sources of data (such as the data sources associated with the data partners server 110), the analytics server system 116 implements machine learning customer segmentation models to further describe groups of fans. For example, the machine learning customer segmentation models may process this data to determine that a segment exists such as: males, age 20-24, in urban areas with high fan avidity for Team X in terms of TV watching. Such machine learning customer segmentation models may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning customer segmentation model may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning customer segmentation models to facilitate identification of correlations between members of the set of data. The machine learning customer segmentation models may be evaluated to determine, based on the sample inputs supplied to the machine learning customer segmentation models, whether the machine learning customer segmentation models are producing accurate correlations between members of the set of data. Based on this evaluation, the machine learning customer segmentation models may be modified to increase the likelihood of the machine learning customer segmentation models identifying the desired correlations. The machine learning customer segmentation models may further be dynamically trained by soliciting feedback from users of a system as to the efficacy of correlations provided by the machine learning customer segmentation models (i.e., the supervision). The machine learning customer segmentation models may use this feedback to improve the algorithm for generating correlations (e.g., the feedback may be used to further train the machine learning customer segmentation models to provide more accurate correlations).

In an embodiment, the machine learning customer segmentation models are dynamically trained by classifying the different sources of data according to a set of vectors of similarity between the data obtained from these different sources (e.g., databases 120-126 as described above in connection with FIG. 1) and clusters of segments corresponding to different audiences for targeting. The machine learning customer segmentation models, in some embodiments, can perform such clustering and obtain partial matches among other clusters of audience segments to identify a particular audience cluster and, from this audience cluster, generate insights for improving ROAS and/or POAS for different properties. In an embodiment, as feedback is obtained from different clients with regard to the generated insights, the analytics server system 116 may dynamically update the set of vectors of similarity to better reflect different audience attributes that may be used to define different audience segments for improving ROAS and/or POAS. Through the dynamic update of the set of vectors of similarity, the analytics server system 116 may perform a re-clustering of the existing audience segments to modify existing clusters of segments and/or define new clusters of segments that may be used to customer segmentation from data obtained from the aforementioned different sources. These modified and/or new clusters of segments may further be used to define new and/or different insights for improving ROAS and/or POAS for different properties.

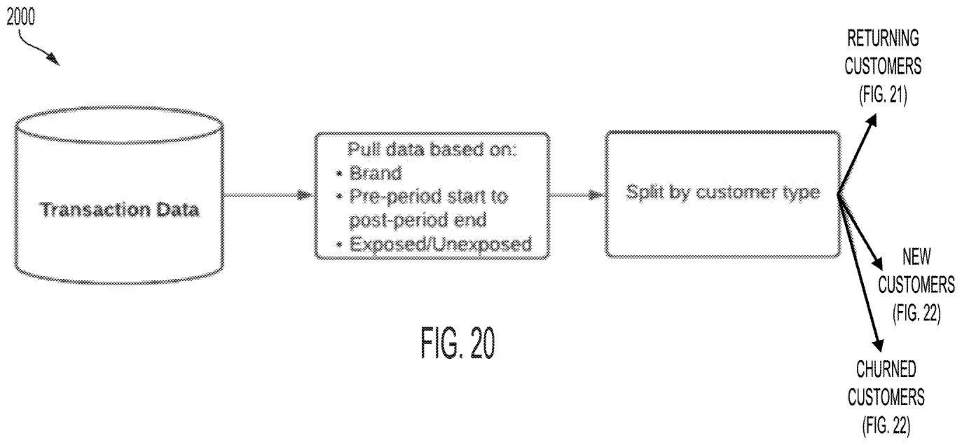

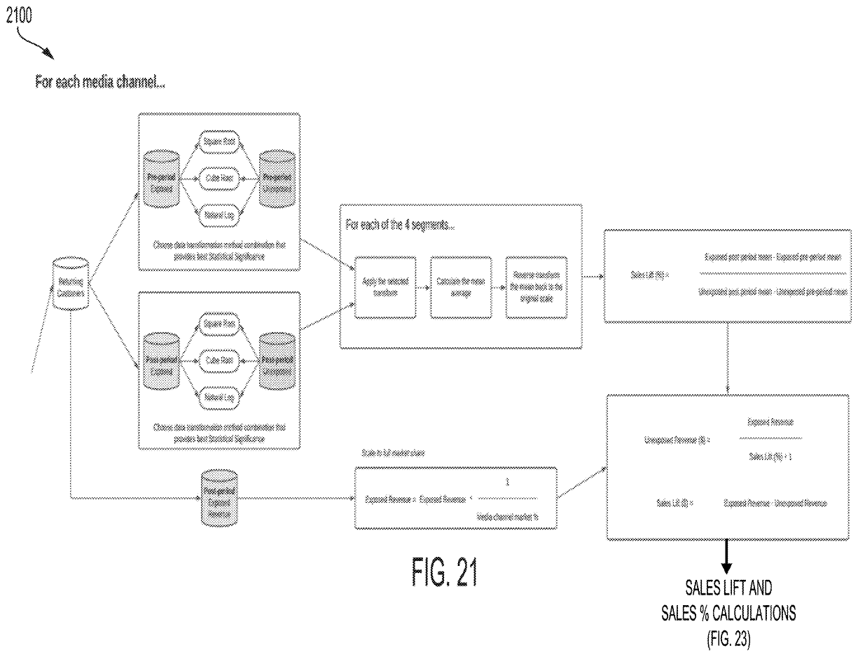

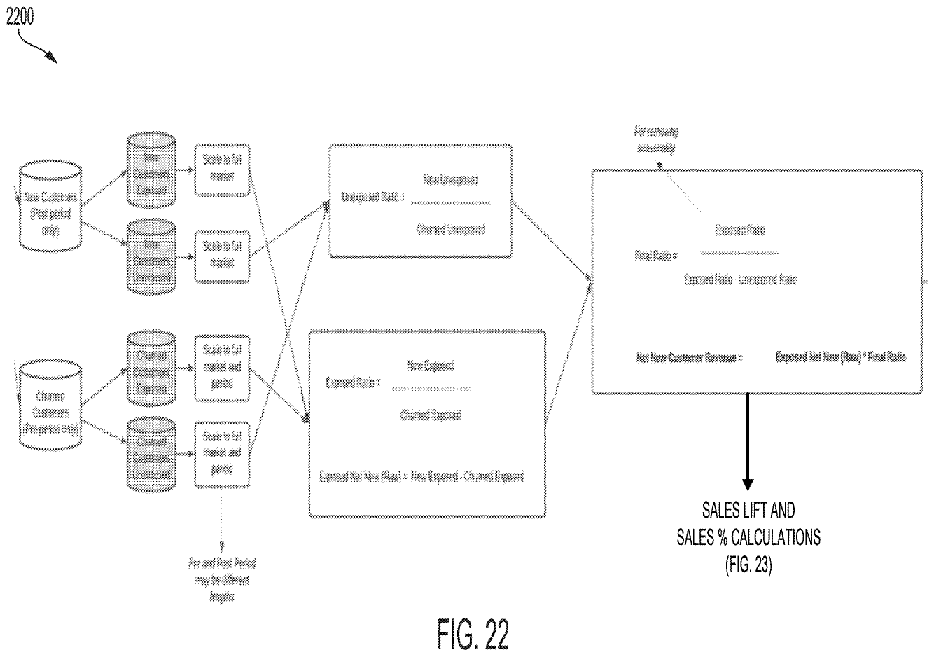

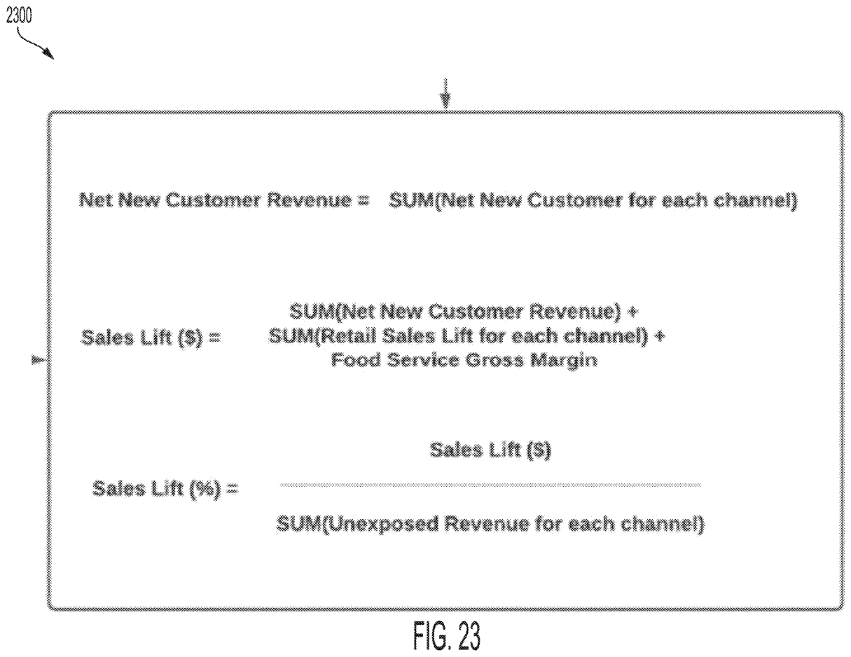

FIGS. 20-23 shows illustrative examples of portions of an example data flow for a process for attribution, including handling different customer types in calculating ROAS in accordance with at least one embodiment. The process illustrated in FIGS. 20-23 is performed by the analytics server system 116 described herein and illustrated in FIG. 1. As illustrated in FIG. 20, the data flow 2000 provides components for receiving transaction data from a data partners server 110 and splitting this data by customer type (such as through the machine learning customer segmentation models described above in connection with FIG. 19). As illustrated in FIG. 21 in the data flow 2100, the analytics server system 116 may perform various operations for data transformations for data corresponding to returning customers in the pre- and post-periods, as described in greater detail herein. As illustrated in FIG. 22 in the data flow 2200, the analytics server system 116 may further perform various operations to determine various metrics for new customers in the post-period and for churned customers in the pre-period, as described in greater detail herein. The data flow 2300 illustrated in FIG. 23, as performed by the analytics server system 116, provides various metrics based on the results obtained from the aforementioned data flows 2000-2200 including net new customer revenue, sales lift (expressed in dollars or other fiat currency), and sales lift percentage.

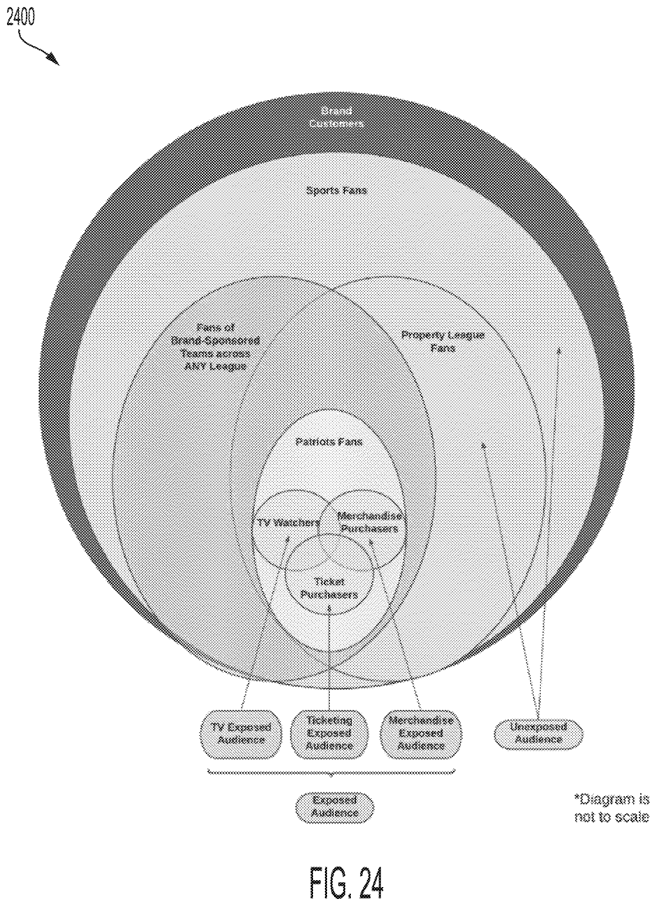

FIG. 24 shows an illustrative example of a diagram 2400 illustrating an unexposed group creation that enables finding sports audiences that are similar yet not exposed to any sponsorship by the brand in accordance with at least one embodiment.

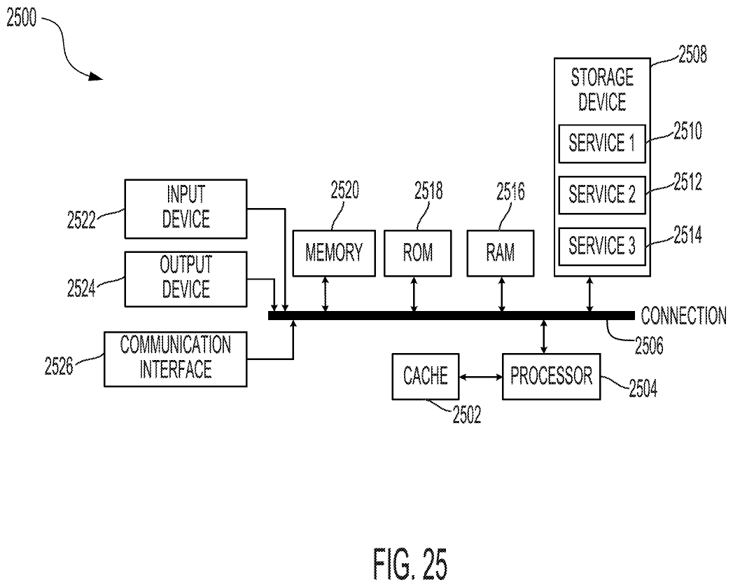

FIG. 25 illustrates a computing system architecture 2500 including various components in electrical communication with each other using a connection 2506, such as a bus, in accordance with some implementations. Example system architecture 2500 includes a processing unit (CPU or processor) 2504 and a system connection 2506 that couples various system components including the system memory 2520, such as ROM 2518 and RAM 2516, to the processor 2504. The system architecture 2500 can include a cache 2502 of high-speed memory connected directly with, in close proximity to, or integrated as part of the processor 2504. The system architecture 2500 can copy data from the memory 2520 and/or the storage device 2508 to the cache 2502 for quick access by the processor 2504. In this way, the cache can provide a performance boost that avoids processor 2504 delays while waiting for data. These and other modules can control or be configured to control the processor 2504 to perform various actions.

Other system memory 2520 may be available for use as well. The memory 2520 can include multiple different types of memory with different performance characteristics. The processor 2504 can include any general purpose processor and a hardware or software service, such as service 1 2510, service 2 2512, and service 3 2514 stored in storage device 2508, configured to control the processor 2504 as well as a special-purpose processor where software instructions are incorporated into the actual processor design. The processor 2504 may be a completely self-contained computing system, containing multiple cores or processors, a bus, memory controller, cache, etc. A multi-core processor may be symmetric or asymmetric.

To enable user interaction with the computing system architecture 2500, an input device 2522 can represent any number of input mechanisms, such as a microphone for speech, a touch-sensitive screen for gesture or graphical input, keyboard, mouse, motion input, speech and so forth. An output device 2524 can also be one or more of a number of output mechanisms known to those of skill in the art. In some instances, multimodal systems can enable a user to provide multiple types of input to communicate with the computing system architecture 2500. The communications interface 2526 can generally govern and manage the user input and system output. There is no restriction on operating on any particular hardware arrangement and therefore the basic features here may easily be substituted for improved hardware or firmware arrangements as they are developed.

Storage device 2508 is a non-volatile memory and can be a hard disk or other types of computer readable media which can store data that are accessible by a computer, such as magnetic cassettes, flash memory cards, solid state memory devices, digital versatile disks, cartridges, RAMs 2516, ROM 2518, and hybrids thereof.

The storage device 2508 can include services 2510, 2512, 2514 for controlling the processor 2504. Other hardware or software modules are contemplated. The storage device 2508 can be connected to the system connection 2506. In one aspect, a hardware module that performs a particular function can include the software component stored in a computer-readable medium in connection with the necessary hardware components, such as the processor 2504, connection 2506, output device 2524, and so forth, to carry out the function.

The disclosed methods can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein for example by executing code for example stored in memory. One or more of a user device or computer, a provider server or system, or a suspended database update system may include the components of the computing system or variations on such a system.

This disclosure contemplates the computer system taking any suitable physical form, including, but not limited to a Point-of-Sale system (“POS”). As example and not by way of limitation, the computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud, which may include one or more cloud components in one or more networks. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor may be, for example, be a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory can be coupled to the processor by, for example, a bus. The memory can include, by way of example but not limitation, random access memory (RAM), such as dynamic RAM (DRAM) and static RAM (SRAM). The memory can be local, remote, or distributed.

The bus can also couple the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software can be stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The bus can also couple the processor to the network interface device. The interface can include one or more of a modem or network interface. It will be appreciated that a modem or network interface can be considered to be part of the computer system. The interface can include an analog modem, Integrated Services Digital network (ISDN0 modem, cable modem, token ring interface, satellite transmission interface (e.g., “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer system can be controlled by operating system software that includes a file management system, such as a disk operating system. One example of operating system software with associated file management system software is the family of operating systems known as Windows® from Microsoft Corporation of Redmond, WA, and their associated file management systems. Another example of operating system software with its associated file management system software is the Linux™ operating system and its associated file management system. The file management system can be stored in the non-volatile memory and/or drive unit and can cause the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any system capable of executing a set of instructions (sequential or otherwise) that specify actions to be taken by that system.

While the machine-readable medium or machine-readable storage medium is shown, by way of example, to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the subject matter to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Client devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things. The input devices can include, for example, a keyboard, a mouse, a key pad, a touch interface, a microphone, a camera, and/or other types of input devices. The output devices can include, for example, a display screen, a speaker, a haptic feedback system, a printer, and/or other types of output devices. A data storage device, such as a hard drive or flash memory, can enable the computing device to temporarily or permanently store data. A network interface, such as a wireless or wired interface, can enable the computing device to communicate with a network. Examples of computing devices include desktop computers, laptop computers, server computers, hand-held computers, tablets, smart phones, personal digital assistants, digital home assistants, as well as machines and apparatuses in which a computing device has been incorporated.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method, comprising:
obtaining data corresponding to different audiences and transactions, wherein the data is associated with a set of common keys that uniquely identify different households;
generating a set of data segments from the data, wherein the set of data segments corresponds to different customer types and the set of common keys;
transforming the set of data segments using a data transformation function, wherein the data transformation function is selected based on a probability threshold, and wherein the probability threshold corresponds to a probability of statistical means between exposed and unexposed groups being identical;
performing a back transformation of the set of data segments according to an inverse of the data transformation function to obtain a set of values corresponding to the set of data segments; and
processing the set of values corresponding to the set of data segments to generate a set of metrics for sponsorships associated with the different audiences and the different households.

2. The computer-implemented method of claim 1, further comprising:
processing the data through one or more machine learning customer segmentation models to generate the set of data segments from the data.

3. The computer-implemented method of claim 1, further comprising:
generating a set of trend insights and a set of actionable insights based on the set of metrics, wherein the set of trend insights and the set of actionable insights include recommendations for new sponsorship investments.

4. The computer-implemented method of claim 1, further comprising:
providing benchmarking data for existing properties compared to other properties, wherein the benchmarking data is generated using the set of metrics.

5. The computer-implemented method of claim 1, further comprising:
generating a set of alerts corresponding to the sponsorships, wherein the set of alerts is triggered according to detected changes to the set of metrics over time; and
transmitting one or more alerts from the set of alerts in response to a change to the set of metrics.

6. The computer-implemented method of claim 1, wherein the set of metrics includes at least a sales lift value of the sponsorships and a sales lift percentage of the sponsorships.

7. The computer-implemented method of claim 1, wherein the data transformation function is selected from a set of data transformation functions including a square root function, a cubic root function, and a natural logarithm function.

8. A system, comprising:
one or more processors; and
memory storing thereon instructions that, as a result of being executed by the one or more processors, cause the system to:
obtain data corresponding to different audiences and transactions, wherein the data is associated with a set of common keys that uniquely identify different households;
generate a set of data segments from the data, wherein the set of data segments corresponds to different customer types and the set of common keys;
transform the set of data segments using a data transformation function, wherein the data transformation function is selected based on a probability threshold, and wherein the probability threshold corresponds to a probability of statistical means between exposed and unexposed groups being identical;
perform a back transformation of the set of data segments according to an inverse of the data transformation function to obtain a set of values corresponding to the set of data segments; and
process the set of values corresponding to the set of data segments to generate a set of metrics for sponsorships associated with the different audiences and the different households.

9. The system of claim 8, wherein the instructions further cause the system to:
process the data through one or more machine learning customer segmentation models to generate the set of data segments from the data.

10. The system of claim 8, wherein the instructions further cause the system to:
generate a set of trend insights and a set of actionable insights based on the set of metrics, wherein the set of trend insights and the set of actionable insights include recommendations for new sponsorship investments.

11. The system of claim 8, wherein the instructions further cause the system to:
provide benchmarking data for existing properties compared to other properties, wherein the benchmarking data is generated using the metrics.

12. The system of claim 8, wherein the instructions further cause the system to:
generate a set of alerts corresponding to the sponsorships, wherein the set of alerts is triggered according to detected changes to the set of metrics over time; and
transmit one or more alerts from the set of alerts in response to a change to the set of metrics.

13. The system of claim 8, wherein the set of metrics includes at least a sales lift value of the sponsorships and a sales lift percentage of the sponsorships.

14. The system of claim 8, wherein the data transformation function is selected from a set of data transformation functions including a square root function, a cubic root function, and a natural logarithm function.

15. A non-transitory computer-readable storage medium storing thereon executable instructions that, as a result of being executed by one or more processors of a computer system, cause the computer system to:
obtain data corresponding to different audiences and transactions, wherein the data is associated with a set of common keys that uniquely identify different households;
generate a set of data segments from the data, wherein the set of data segments corresponds to different customer types and the set of common keys;
transform the set of data segments using a data transformation function, wherein the data transformation function is selected based on a probability threshold, and wherein the probability threshold corresponds to a probability of statistical means between exposed and unexposed groups being identical;
perform a back transformation of the set of data segments according to an inverse of the data transformation function to obtain a set of values corresponding to the set of data segments; and
process the set of values corresponding to the set of data segments to generate a set of metrics for sponsorships associated with the different audiences and the different households.

16. The non-transitory computer-readable storage medium of claim 15, wherein the executable instructions further cause the computer system to:
process the data through one or more machine learning customer segmentation models to generate the set of data segments from the data.

17. The non-transitory computer-readable storage medium of claim 15, wherein the executable instructions further cause the computer system to:
generate a set of trend insights and a set of actionable insights based on the set of metrics, wherein the set of trend insights and the set of actionable insights include recommendations for new sponsorship investments.

18. The non-transitory computer-readable storage medium of claim 15, wherein the executable instructions further cause the computer system to:
provide benchmarking data for existing properties compared to other properties, wherein the benchmarking data is generated using the metrics.

19. The non-transitory computer-readable storage medium of claim 15, wherein the executable instructions further cause the computer system to:
generate a set of alerts corresponding to the sponsorships, wherein the set of alerts is triggered according to detected changes to the set of metrics over time; and
transmit one or more alerts from the set of alerts in response to a change to the set of metrics.

20. The non-transitory computer-readable storage medium of claim 15, wherein the set of metrics includes at least a sales lift value of the sponsorships and a sales lift percentage of the sponsorships.

21. The non-transitory computer-readable storage medium of claim 15, wherein the data transformation function is selected from a set of data transformation functions including a square root function, a cubic root function, and a natural logarithm function.
